(19) United States
(12) Patent Application Publication
(10) Pub. No.: US 2013/0133537 A1
(43) Pub. Date: May 30, 2013

(54) RESIN COMPOSITION FOR LASER ENGRAVING, FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM Corporation, Tokyo (JP)

(72) Inventor: Kenji WADA, Haibara-gun (JP)

(73) Assignee: FUJIFILM Corporation, Tokyo (JP)

(21) Appl. No.: 13/686,344

(22) Filed: Nov. 27, 2012

(30) Foreign Application Priority Data
Nov. 28, 2011 (JP) 2011-259410

(51) Int. Cl. C08L 33/08

(52) U.S. Cl. CPC C08L 33/08
USPC 101/395; 526/320; 526/328; 525/55; 525/342; 525/301; 524/558; 524/560; 524/290; 524/92; 264/400; 427/554

(57) ABSTRACT

Disclosed is a resin composition for laser engraving, comprising:
(Component A) a polymer having a constituent unit derived from an ethylenically unsaturated monomer, and having at least two functional groups selected from the group consisting of an ethylenically unsaturated group, a hydroxyl group, and an alkoxysilyl group at the main chain ends.

### BACKGROUND OF THE INVENTION

1. Technical Field

The present invention relates to a resin composition for laser engraving, a flexographic printing plate precursor for laser engraving and a process for producing the same, and a flexographic printing plate and a process for making the same.

2. Background Art

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

Processes for producing a resin having specific construction are described in Japanese Patent No. 3639859, JP-A-2008-81738 and JP-A-2005-226051. Herein “JP-A” denotes a unexamined published Japanese patent application.

### SUMMARY OF THE INVENTION

### Problems to be Solved by the Invention

An object of the present invention is to provide a resin composition for laser engraving from which a flexographic printing plate having an excellent strength of the relief layer and an excellent print durability may be obtained, a flexographic printing plate precursor using the resin composition for a flexographic printing plate, a process for producing the flexographic printing plate precursor, a flexographic printing plate, and a process for making the flexographic printing plate.

### Means for Solving the Problems

The problems of the present invention described above have been solved by the following means <1>, <12>, <14>, <16>, <17> and <18>. Preferred embodiments <2> to <11>, <13>, <15> and <19> will also be described below.

<1> A resin composition for laser engraving, comprising: (Component A) a polymer having a constituent unit derived from an ethylenically unsaturated monomer, and having at least two functional groups selected from the group consisting of an ethylenically unsaturated group, a hydroxyl group, and an alkoxysilyl group at the main chain ends;
<2> The resin composition for laser engraving as described in <1>, wherein the molecular weight dispersity (Mw/Mn) of Component A is at least 1.0 but no greater than 1.6;
<3> The resin composition for laser engraving as described in <1>, wherein Component A is a linear polymer represented by Formula (I):

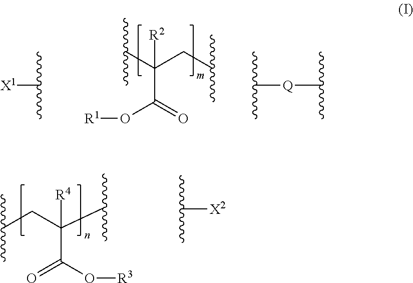

wherein Q represents a divalent organic linking group; R¹ and R³ each independently represent an alkyl group; R² and R⁴ each independently represent a hydrogen atom or a methyl group; X¹ and X² are respectively located at the main chain ends and each independently represent an organic residue having a group selected from the group consisting of an ethylenically unsaturated group, a hydroxyl group, and an alkoxysilyl group at the end; m and n each independently represent an integer of 4 to 1,000; and a wavy line portion represents a position of bonding to another structure;
<4> The resin composition for laser engraving as described in <2>, wherein Component A is a linear polymer represented by Formula (I):

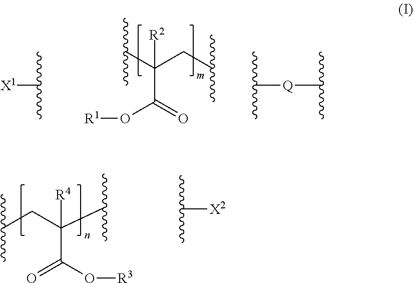

wherein Q represents a divalent organic linking group; R¹ and R³ each independently represent an alkyl group; R² and R⁴ each independently represent a hydrogen atom or a methyl group; X¹ and X² are respectively located at the main chain ends and each independently represent an organic residue having a group selected from the group consisting of an ethylenically unsaturated group, a hydroxyl group, and an alkoxysilyl group at the end; m and n each independently represent an integer of 4 to 1,000; and a wavy line portion represents a position of bonding to another structure;
<5> The resin composition for laser engraving as described in <1>, wherein Component A is a linear polymer represented by Formula (II):

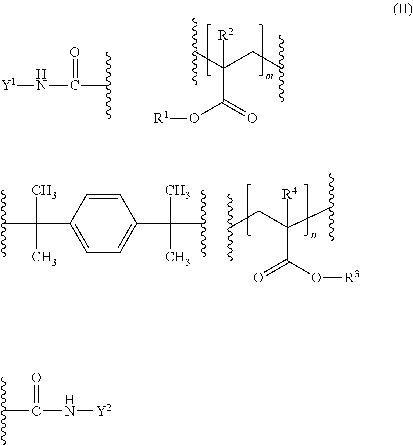

wherein R¹ and R³ each independently represent an alkyl group; R² and R⁴ each independently represent a hydrogen atom or a methyl group; Y¹ and Y² each independently represent an organic residue having a group selected from the group consisting of an ethylenically unsaturated group, a hydroxyl group, and an alkoxysilyl group at the end; m and n each independently represent an integer of 4 to 1,000; and a wavy line portion represents a position of bonding to another structure;
<6> The resin composition for laser engraving as described in any one of <2> to <4>, wherein Component A is a linear polymer represented by Formula (II):

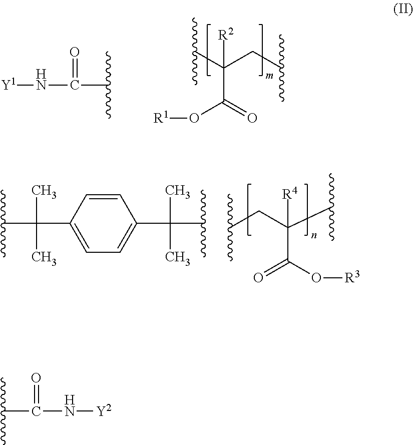

wherein R¹ and R³ each independently represent an alkyl group; R² and R⁴ each independently represent a hydrogen atom or a methyl group; Y¹ and Y² each independently represent an organic residue having a group selected from the group consisting of an ethylenically unsaturated group, a hydroxyl group, and an alkoxysilyl group at the end; m and n each independently represent an integer of 4 to 1,000; and a wavy line portion represents a position of bonding to another structure;
<7> The resin composition for laser engraving as described in <5> or <6>, wherein m and n each independently represent an integer of about 100 to about 300 in Formula (II),
<8> The resin composition for laser engraving as described in any one of <1> to <7>, wherein the resin composition further comprises (Component B) a crosslinking agent;
<9> The resin composition for laser engraving as described in <1>, wherein Component B is a silane coupling agent or a polyfunctional (meth)acrylate;
<10> The resin composition for laser engraving as described in any one of <1> to <9>, further comprising (Component C) a photothermal conversion agent;
<11> The resin composition for laser engraving as described in any one of <1> to <10>, further comprising a tertiary amine and/or an organic peroxide as (Component D) a crosslinking accelerating agent;
<12> A flexographic printing plate precursor for laser engraving, wherein the flexographic printing plate precursor has a relief-forming layer comprising the resin composition for laser engraving as described in any one of <1> to <11>;
<13> A flexographic printing plate precursor for laser engraving, wherein the flexographic printing plate precursor has a crosslinked relief-forming layer produced by crosslinking a relief-forming layer comprising the resin composition for laser engraving as described in any one of <1> to <11>, by means of light and/or heat;
<14> A process for producing a flexographic printing plate precursor for laser engraving, wherein the process comprises, a layer forming step of forming a relief-forming layer comprising the resin composition for laser engraving as described in any one of <1> to <11>, and a crosslinking step of crosslinking the relief-forming layer by means of light and/or heat to obtain a flexographic printing plate precursor having a crosslinked relief-forming layer;
<15> The process for producing a flexographic printing plate precursor for laser engraving as described in <14>, wherein the crosslinking step is a step of crosslinking the relief-forming layer by heat to obtain the flexographic printing plate precursor having the crosslinked relief-forming layer;
<16> A process for making a flexographic printing plate, comprising an engraving step of laser-engraving the flexographic printing plate precursor as described in <13> to thus form a relief layer.
<17> A flexographic printing plate having a relief layer made by the process for making a flexographic printing plate as described in <16>;
<18> A process for making a flexographic printing plate, comprising: a step of preparing a flexographic printing plate precursor, produced by a coating step of applying, on the support, a resin composition comprising (Component A) a polymer that has a constituent unit derived from an ethylenically unsaturated monomer, has at least two functional groups selected from the group consisting of an ethylenically unsaturated group, a hydroxyl group and an alkoxysilyl group at the main chain ends, and has a molecular weight dispersity (Mw/Mn) of at least 1.0 but no greater than 1.6, and a curing step (2) of thermally curing the resin composition, and an step of laser-engraving the flexographic printing plate precursor.
<19> The process for making a flexographic printing plate as described in <18>, comprising, subsequently to the step (1) and the step (2), a step of providing a photocurable composition layer on the surface of the thermally cured resin composition, and a step of pasting another light-transmissive support on the photocurable composition layer, and a step of photo-curing the photocurable composition.

### DETAILED DESCRIPTION OF THE INVENTION

### Modes for Carrying Out the Invention

The present invention is explained in detail below.

In the present invention, the notation ‘lower limit to upper limit’ expressing a numerical range means ‘at least the lower limit but no greater than the upper limit’, and the notation ‘upper limit to lower limit’ means ‘no greater than the upper limit but at least the lower limit’. That is, they are numerical ranges that include the upper limit and the lower limit. Further, “(Component A) Polymer having a constituent unit derived from an ethylenically unsaturated monomer and having at least two functional groups selected from the group consisting of an ethylenically unsaturated group, a hydroxyl group and an alkoxysilyl group at the main chain ends” etc. are simply called “Component A” etc.

(Resin Composition for Laser Engraving)

The resin composition for laser engraving of the present invention (hereinafter, also referred to simply as “resin composition”) comprises (Component A) a polymer having a constituent unit derived from an ethylenically unsaturated monomer, and having at least two functional groups selected from the group consisting of a radical polymerizable group, a hydroxyl group and an alkoxysilyl group at the main chain ends. The radical polymerizable group is preferably an ethylenically unsaturated group, and hereinafter, the resin composition for laser engraving will be described by taking an ethylenically unsaturated group as a representative example.

The resin composition for laser engraving of the present invention may be used without any particular limitation in a wide range of other applications in addition to a relief-forming layer of a flexographic printing plate precursor that is subjected to laser engraving. For example, it may be used not only in formation of a relief-forming layer of a printing plate precursor for which formation of a raised relief is carried out by laser engraving, which is described in detail later, but also in formation of another material form in which asperities or apertures are formed on the surface, for example, various types of printing plates or various types of moldings in which an image is formed by laser engraving, such as an intaglio plate, a stencil plate, or a stamp.

Among them, a preferred embodiment is use in formation of a relief-forming layer provided on an appropriate support.

In the present specification, when a flexographic printing plate precursor is explained, a layer that comprises Component A, that serves as an image-forming layer subjected to laser engraving, that has a flat surface, and that is an uncrosslinked crosslinkable layer is called a relief-forming layer, a layer that is formed by crosslinking the relief-forming layer is called a crosslinked relief-forming layer, and a layer that has asperities formed on the surface by laser engraving the crosslinked relief-forming layer is called a relief layer.

Constituent components of the resin composition for laser engraving are explained below.

(Component A) Polymer having a constituent unit derived from an ethylenically unsaturated monomer and having at least two functional groups selected from the group consisting of an ethylenically unsaturated group, a hydroxyl group and an alkoxysilyl group at the main chain ends

The resin composition for laser engraving of the present invention comprises (Component A) a polymer having a constituent unit derived from an ethylenically unsaturated monomer and having at least two functional groups selected from the group consisting of an ethylenically unsaturated group, a hydroxyl group and an alkoxysilyl group at the main chain ends.

These functional groups present at the ends of the main chain preferably constitute a mutually reactive combination.

The group having an ethylenically unsaturated group is preferably an organic group having an ethylenically unsaturated bond, and having 1 to 20 carbon atoms, and more preferably 2 to 10 carbon atoms. Examples thereof include groups having an addition polymerizable ethylenically unsaturated bond (also called “ethylenically unsaturated group”) such as (meth)acrylic acid esters, (meth)acrylamide, allyl, vinyl, vinyl ethers, and vinyl esters. Among them, preferred examples include a (meth)acryloxy group, a (meth)acrylamide group, an allyl group, a vinyl group, and a vinyloxycarbonyl group, and more preferred examples include an acryloxy group, a methacryloxy group, an allyl group, and a vinyl group. When these groups are selected, a film having a high elastic modulus may be obtained.

The alkoxysilyl group may be a monoalkoxysilyl group, a dialkoxysilyl group, or a trialkoxysilyl group, but the alkoxysilyl group is preferably a group represented by the following Formula (1):

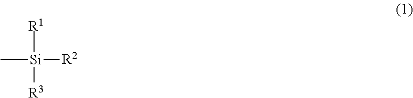

wherein in Formula (1), R¹ to R³ each independently represent a hydrogen atom, a hydroxyl group, a halogen atom, an alkyl group, and an alkoxy group, and at least one of R¹ to R³ is an alkoxy group.

In Formula (1), R¹ to R³ each independently represent a hydrogen atom; a hydroxyl group; a halogen atom such as a fluorine atom, a chlorine atom, a bromine atom, or an iodine atom; an alkyl group having 1 to 30 carbon atoms which may have a linear structure or a branched structure; or an alkoxy group having 1 to 15 carbon atoms which may have a linear structure or a branched structure, and at least one of R¹ to R³ is an alkoxy group.

At least one of R¹ to R³ is an alkoxy group. The alkoxy group is preferably an alkoxy group having 1 to 15 carbon atoms, more preferably an alkoxy group having 1 to 8 carbon atoms, even more preferably an alkoxy group having 1 to 4 carbon atoms, and particularly preferably an ethoxy group or a methoxy group.

When any one of R¹ to R³ is a halogen atom, examples of the halogen atom include a fluorine atom, a chlorine atom, a bromine atom, and an iodine atom, but the halogen atom is preferably a chlorine atom or a bromine atom, and more preferably a chlorine atom.

When any one of R¹ to R³ is an alkyl group, the alkyl group is preferably an alkyl group having 1 to 30 carbon atoms, more preferably an alkyl group having 1 to 12 carbon atoms, even more preferably an alkyl group having 1 to 8 carbon atoms, and particularly preferably an alkyl group having 1 to 3 carbon atoms.

In the present invention, R¹ to R³ are preferably such that two of them are alkoxy groups, while one is an alkyl group, or three of them are alkoxy groups. Among others, the group is preferably a trialkoxysilyl group in which three of R¹ to R³ are alkoxy groups, and particularly preferably a trialkoxysilyl group having three alkoxy groups each having 1 to 4 carbon atoms.

The ethylenically unsaturated monomer means a compound having an addition polymerizable ethylenically unsaturated bond (hereinafter, also called “polymerizable compound”). Examples thereof include various polymerizable compounds having ethylenically unsaturated groups and other functional groups, such as substituted or unsubstituted alkyl (meth)acrylates, α,β-unsaturated carboxylic acids, monomers having a sulfonamide group, (meth)acrylamides, monomers having an aminosulfonyl group, monomers containing a fluorinated alkyl group, vinyl ethers, vinyl esters, styrenes, vinyl ketones, olefins, N-vinylpyrrolidone, N-vinylcarbazole, 4-vinylpyridine, monomers having a cyano group, and monomers having an amino group.

Specific examples of the ethylenically unsaturated monomer that may be suitably used in the present invention will be described below, but the present invention is not intended to be limited to these monomers.

Substituted or unsubstituted alkyl acrylates: Examples include methyl acrylate, ethyl acrylate, propyl acrylate, butyl acrylate, amyl acrylate, hexyl acrylate, heptyl acrylate, octyl acrylate, nonyl acrylate, decyl acrylate, undecyl acrylate, dodecyl acrylate, benzyl acrylate, cyclohexyl acrylate, 2-chloroethyl acrylate, N,N-dimethylaminoethyl acrylate, and glycidyl acrylate.

Substituted or unsubstituted alkyl methacrylates: Examples include methyl methacrylate, ethyl methacrylate, propyl methacrylate, butyl methacrylate, amyl methacrylate, hexyl methacrylate, heptyl methacrylate, octyl methacrylate, nonyl methacrylate, decyl methacrylate, undecyl methacrylate, dodecyl methacrylate, benzyl methacrylate, cyclohexyl methacrylate, 2-chloroethyl methacrylate, N,N-dimethylaminoethyl methacrylate, and glycidyl methacrylate.

α,β-unsaturated carboxylic acids: Examples include acrylic acid, methacrylic acid, maleic acid, maleic anhydride, itaconic acid, and itaconic anhydride.

Monomers having a sulfonamide group: Examples include N-(p-toluenesulfonyl)acrylamide, and N-(p-toluenesulfonyl)methacrylamide.

(Meth)acrylamides: Examples include acylamide, methacrylamide, N-ethylacrylamide, N-hexylacrylamide, N-cyclohexylacrylamide, N-phenylacrylamide, N-nitrophenylacrylamide, N-ethyl-N-phenylacrylamide, N-(4-hydroxyphenyl)acrylamide, N-(4-hydroxyphenyl)acrylamide, and N-(4-hydroxyphenyl)methacrylamide.

Monomers having an aminosulfonyl group: Examples include m-aminosulfonylphenyl methacrylate, p-aminosulfonylphenyl methacrylate, m-aminosulfonylphenyl acrylate, p-aminophenyl acrylate, N-(p-aminosulfonylphenyl)methacrylamide, and N-(p-aminosulfonylphenyl)acrylamide.

Monomers containing a fluorinated alkyl group: Examples include trifluoroethyl acrylate, trifluoroethyl methacrylate, tetrafluoropropyl methacrylate, hexafluoropropyl methacrylate, octafluoropenyl acrylate, octafluoropentyl methacrylate, heptadecafluorodecyl methacrylate, and N-butyl-N-(2-acryloxyethyl)heptadecafluorooctyl sulfonamide.

Vinyl ethers: Examples include ethyl vinyl ether, 2-chloroethyl vinyl ether, propyl vinyl ether, butyl vinyl ether, octyl vinyl ether, and phenyl vinyl ether.

Vinyl esters: Examples include vinyl acetate, vinyl chloroacetate, vinyl butyrate, and vinyl benzoate.

Styrenes: Examples include styrene, methylstyrene, and chloromethylstyrene.

Vinyl ketones: Examples include methyl vinyl ketone, ethyl vinyl ketone, propyl vinyl ketone, and phenyl vinyl ketone.

Olefins: Examples include ethylene, propylene, isobutylene, butadiene, and isoprene.

N-vinylpyrrolidone, N-vinylcarbazole, and 4-vinylpyridine.

Monomer having a cyano group: Examples include acrylonitrile, methacrylonitrile, 2-pentenenitrile, 2-methyl-3-butenenitrile, 2-cyanoethyl acrylate, o-cyanostyrene, m-cyanostyrene, and p-cyanostyrene.

Monomers having an amino group: Examples include N,N-diethylaminoethyl methacrylate, N,N-dimethylaminoethyl acrylate, N,N-dimethylaminoethyl methacrylate, polybutadiene urethane acrylate, N,N-dimethylaminopropylacrylamide, N,N-dimethylacrylamide, acryloylmorpholine, N-isopropylacrylamide, and N,N-diethylacrylamide.

Preferred examples of the ethylenically unsaturated monomer include substituted or unsubstituted alkyl acrylates, substituted or unsubstituted alkyl methacrylates, vinyl ethers, vinyl esters, styrenes, and olefins, and more preferred examples include unsubstituted alkyl acrylates, and substituted or unsubstituted alkyl methacrylates. In the embodiments described above, the engraving sensitivity is improved.

Component A is such that the molecular weight dispersity (Mw/Mn) is preferably 1.6 or less, more preferably at least 1.0 but no greater than 1.6, and even more preferably at least 1.0 but no greater than 1.5. As such, when the molecular weight dispersity is adjusted to a narrow dispersion range, the effective mesh size distribution in the crosslinked film derived from Component A is narrowly dispersed, and the crosslinked film exhibits satisfactory breaking elongation without any external stress being locally concentrated.

A resin having such a small dispersity may be synthesized by, for example, living radical polymerization.

Living radical polymerization using a living radical polymerization initiator means radical polymerization in which the activity of polymer ends is maintained without being lost, and pseudo-living polymerization in which polymer chains with inactivated ends and polymer chains with activated ends are in an equilibrium state is also included. Examples of the method of living radical polymerization include a method of using a chain transfer agent such as a polysulfide; a method of using a radical scavenger such as a cobalt-porphyrin complex (J. Am. Chem. Soc., 1994, 116, 7943) or a nitroxide compound (Macromolecules, 1994, 27, 7228); atom transfer radical polymerization using an organic halide or the like as an initiator, and using a transition metal complex as a catalyst (JP-A-2002-145972, JP-A-2002-80523, JP-A-2001-261733, and JP-A-2000-264914); and a method of using a compound having a thiocarbonylthio moiety (RCSS) at a growing end (Japanese Patent No. 3639859, WO 98/01478, WO 98/58974, WO 99/35177, WO 99/31144, and U.S. Pat. No. 6,380,335).

A resin obtained by such a living radical polymerization method has an initiator-derived residue at the molecular chain ends. This residue may be converted to a functional group by using a radical polymerization initiator, as described in the following reference documents.

Biomacromolecules 2011, 12, 247-252, Macromolecules 2005, 38, 8597-8602, Macromolecules 2010, 43, 5195-5204, Macromolecules 2011, 44, 2481-2488, Macromolecules 2011, 44, 5352-5362, Macromolecules 2011, 44, 5619-5630, Macromolecules 2010, 43, 7453-7464, and Macromolecules 2011, 44, 2034-2049.

The polymer end treatment may be carried out on the polymerization reaction product after completion of the living radical polymerization reaction, or a polymer once produced may be purified and then subjected to the polymer end treatment.

Regarding the radical polymerization initiator that may be used, any compound which is capable of generating a radical under the conditions of the molecular chain end group treatment may be used. The conditions for radical generation include heat, light, and high energy radiations such as gamma-rays and electron beams.

Specific examples of the radical polymerization initiator include initiators such as peroxides and azo compounds.

Through this polymer end treatment, the chain ends of the polymer are substituted with a new radical species, for example, a fragment of a radical initiator derived from the radical initiator used in the polymer end treatment reaction. The polymer thus obtained has a new group at the chain ends, and may be used in accordance with the uses.

Meanwhile, the polymer end treatment may also be carried out according to the method described in WO 02/090397 to remove a residue derived from the polymerization initiator.

A synthesis method for a polymer having hydroxyl groups at both ends of the main chain will be described below.

The basic structure of Component A is a polymer in which an ethylenically unsaturated monomer such as described above has been addition polymerized, and the polymer may be obtained by a known polymerization method. For example, by means of living polymerization method in which 1,4-bis(2-thiobenzoylthioprop-2-yl)benzene described in Example 40 of Japanese Patent No. 3639859 is employed as a chain transfer agent used in reversible addition fragmentation chain transfer polymerization (RAFT agent), a polymer having a constituent unit derived from an acrylic monomer having a RAFT agent residue at the ends may be obtained. When the RAFT agent residue at the ends of this polymer is subjected to a polymer end treatment by using an arbitrary radical source (for example, an azo-based polymerization initiator), a polymer in which the RAFT agent residues at both ends of the polymer are substituted by other functional groups may be obtained. At this time, if an azo-based polymerization initiator containing a substituent having a hydroxyl group (for example, VA-086 and VA-080 manufactured by Wako Pure Chemical Industries, Ltd.) is used, a polymer in which both ends of the main chain are substituted with a hydroxyl group may be obtained.

A polymer having an ethylenically unsaturated group at both ends of the main chain will be described below.

The method for producing a polymer having an ethylenically unsaturated at both ends of the main chain is not particularly limited, but for example, such a polymer may be obtained by allowing a hydroxyl group of a polymer having a hydroxyl group at both ends of the main chain obtained as described above, and a compound having a functional group capable of reacting with the hydroxyl group and also having an ethylenically unsaturated group (for example, an unsaturated carboxylic acid halide, an isocyanate compound having an ethylenically unsaturated group, or an epoxy compound having an ethylenically unsaturated group) to react with each other by a known method.

A polymer having an alkoxysilyl group at both ends of the main chain will be described below.

The method for producing a polymer having an alkoxysilyl group at both ends of the main chain is not particularly limited, but for example, such a polymer may be obtained, for example, according to the method described in Example 1 of JP-A-2008-81738, by obtaining an acrylic acid ester-based polymer having an alkenyl group at both ends of the polymer as an intermediate, and then allowing the polymer to react with an alkoxysilane.

Component A for use in this invention is preferably a polymer represented by Formula (I) below.

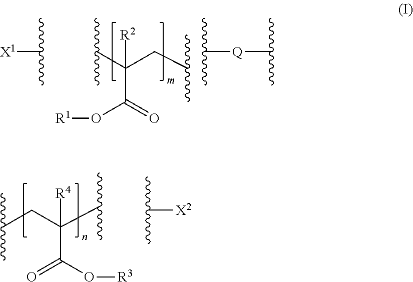

wherein in Formula (I), Q represents a divalent organic linking group; R¹ and R³ each independently represent an alkyl group; R² and R⁴ each independently represent a hydrogen atom or a methyl group; X¹ and X² are respectively located at the main chain ends and each independently represent an organic residue having a group selected from the group consisting of an ethylenically unsaturated group, a hydroxyl group, and an alkoxysilyl group at the end; m and n each independently represent an integer of 4 to about 1,000; and a wavy line portion represents a position of bonding to another structure;

Component A is preferably a polymer in which five groups in Formula (I) are combined in sequence from the left side to the right side.

In Formula (I), Q represents a divalent organic linking group, and is preferably an alkylene group having 1 to 30 carbon atoms which may be substituted, an arylene group having 6 to 30 carbon atoms which may be substituted, or a group combining two or more of these groups. Preferred examples of the substituent for these groups include an alkyl group having 1 to 10 carbon atoms, an alkoxy group having 1 to 10 carbon atoms, a cyano group, a vinyl group, and an alkoxycarbonyl group having 1 to 10 carbon atoms. Among them, Q is preferably a phenylene group, an alkylene group having 4 to 8 carbon atoms, and a group combining these groups; and is more preferably an alkylene group having 4 to 8 carbon atoms, or a 1,4-bisalkylenebenzene group having 8 to 14 carbon atoms in total.

In Formula (I), R¹ and R³ each independently represent an alkyl group which may be substituted, and the alkyl group may be linear, branched, or alicyclic. Preferred examples of the substituent for the alkyl group include an alkyl group having 1 to 10 carbon atoms, an alkoxy group having 1 to 10 carbon atoms, a cyano group, a vinyl group, and an alkoxycarbonyl group having 1 to 10 carbon atoms; and a particularly preferred example is an alkoxy group having 1 to 10 carbon atoms. Among them, an alkyl group having 1 to 10 carbon atoms, or an alkoxyalkyl group having 2 to 10 carbon atoms is preferable; an alkyl group having 2 to 10 carbon atoms is more preferable; and an n-butyl group is particularly preferable.

In Formula (I), R² and R⁴ each independently represent a hydrogen atom or a methyl group, and a hydrogen atom is more preferable.

In Formula (I), X¹ and X² are respectively located at the ends of the main chain, and each independently represent an organic residue having a group selected from the group consisting of an ethylenically unsaturated group, a hydroxyl group, and an alkoxysilyl group, at an end. Preferred examples of the ethylenically unsaturated group and the alkoxysilyl group for X¹ and X² are the same as the respective preferred examples described above, and it is particularly preferable that the organic residue be a group having a (meth)acryloyl group, or a trialkoxysilyl group having three alkoxy groups each having 1 to 4 carbon atoms.

Among them, a monovalent organic residue having 1 to 20 carbon atoms and having a (meth)acryloxy group, a hydroxyl group, a dialkoxysilyl group or a trialkoxysilyl group at an end is preferable, and an alkylaminocarbonyl group having 3 to 20 carbon atoms and having a (meth)acryloxy group, a hydroxyl group, a dialkoxysilyl group, or a trialkoxysilyl group at an end is more preferable.

In Formula (I), m and n each independently represent an integer of 4 to about 1,000, and is preferably an integer of 4 to about 300.

In Formula (I), it is preferable that R¹ and R³ represent the same group, and it is preferable that R² and R⁴ represent the same group. It is also preferable that X¹ and X² represent the same group.

Component A used in this invention is preferably a polymer represented by Formula (II).

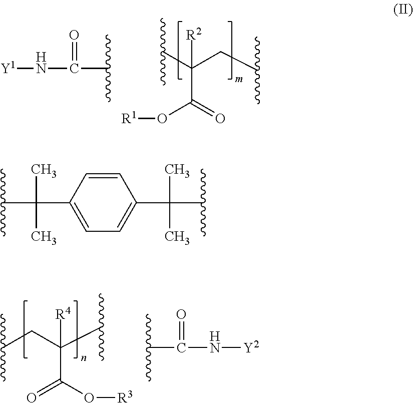

wherein in Formula (II), R¹ and R³ each independently represent an alkyl group; R² and R⁴ each independently represent a hydrogen atom or a methyl group; Y¹ and Y² each independently represent an organic residue having a group selected from the group consisting of an ethylenically unsaturated group, a hydroxyl group, and an alkoxysilyl group at the end; m and n each independently represent an integer of 4 to 1,000; and a wavy line portion represents a position of bonding to another structure.

Component A is preferably a polymer in which five groups in Formula (II) are combined in sequence from the left side to the right side.

In Formula (II), R¹ and R³ each independently represent an alkyl group, and the alkyl group may be linear, branched, or alicyclic, and may also be substituted. Examples of the substituent for R¹ and R³ that are acceptable include an alkyl group having 1 to 10 carbon atoms, an alkoxy group having 1 to 10 carbon atoms, a cyano group, a vinyl group, and an alkoxycarbonyl group having 1 to 10 carbon atoms, and an alkoxy group having 1 to 10 carbon atoms is particularly preferable. Among them, it is preferable that R¹ and R³ both represent an alkyl group having 1 to 10 carbon atoms, or both represent an alkoxyalkyl group having 2 to 10 carbon atoms in total, and specific preferred examples thereof include an alkyl group having 2 to 6 carbon atoms, and an alkoxyalkyl group having 3 to 6 carbon atoms in total. An n-butyl group or a methoxyethyl group is particularly preferable.

In Formula (II), R² and R⁴ each independently represent a hydrogen atom or a methyl group, and it is preferable that both represent a hydrogen atom.

In Formula (II), Y¹ and Y² each independently represent an organic residue having a group selected from the group consisting of an ethylenically unsaturated group, a hydroxyl group, and an alkoxysilyl group, at an end. The total number of carbon atoms of Y¹ and Y² is preferably 2 to 20, and preferred examples of the ethylenically unsaturated group and alkoxysilyl group described for X¹ and X² in regard to Formula (I) are respectively the same as the preferred examples of Y¹ and Y². The organic residue is particularly preferably a group having a (meth)acryloyl group, or a trialkoxysilyl group having three alkoxy groups each having 1 to 4 carbon atoms.

Among them, a monovalent organic residue having 1 to 20 carbon atoms and having a (meth)acryloxy group, a hydroxyl group, a dialkoxysilyl group or a trialkoxysilyl group at an end is preferable; and an alkylene group having 2 to 20 carbon atoms and having a (meth)acryloxy group, a dialkoxysilyl group or a trialkoxysilyl group is more preferable. The organic residue is preferably a 2-hydroxyethyl group, a 2-(meth)acryloxyethyl group, a tris(2-hydroxyethyl)methyl group, or a 2-trialkoxysilylethyl group, and particularly preferably a tris(2-hydroxyethyl)methyl group.

In Formula (II), m and n each independently represent an integer of 4 to about 1,000, preferably an integer of 4 to about 300, and most preferably about 100 to about 300.

In Formula (II), it is preferable that R¹ and R³ represent the same group, and it is preferable that R² and R⁴ represent the same group. Furthermore, it is preferable that Y¹ and Y² represent the same group.

With regard to Component A in the resin composition of the present invention, only one type may be used or two or more types thereof may be used in combination.

The number average molecular weight of Component A is preferably at least 5,000 but no greater than 500,000, more preferably, at least 5,000 but no greater than 300,000, even more preferably at least 15,000 but no greater than 200,000, and yet more preferably at least 30,000 but no greater than 100,000. When in the above-mentioned range, the strength of a relief printing plate precursor and a relief printing plate is excellent. In addition, a solution viscosity of the resin composition for relief-printing is appropriate for forming a relief-forming layer and therefore manufacturing of a relief-printing plate precursor and a relief printing plate becomes easy.

Meanwhile, the number average molecular weight according to the present invention is determined by measurement by gel permeation chromatography (GPC) and calculated by calibrating with polystyrenes with known molecular weights.

The solid content of Component A in the total solid of the resin composition is not particularly limited, but the solid content is preferably in the range of 2 to 80 wt %, more preferably in the range of 5 to 70 wt %, and most preferably 10 to 60 wt %, relative to the total solids content. Moreover, the total solid content of the resin composition represents the quantity of all solids after removing volatile components such as solvents.

The resin composition for laser engraving of the present invention may comprise a binder polymer other than Component A. Examples of the binder polymer other than Component A include the non-elastomers described in JP-A-2011-136455, and the unsaturated group-containing polymers described in JP-A-2010-208326.

The resin composition for laser engraving of the present invention preferably comprises Component A as a main component of binder polymers (resin components), and when the resin composition comprises other binder polymers, the content of Component A in the total amount of the binder polymers is preferably 60 wt % or greater, more preferably 70 wt % or greater, and even more preferably 80 wt % or greater. The upper limit of the content of Component A is not particularly limited, but when the resin composition for laser engraving includes other binder polymers, the upper limit thereof is preferably 95 wt % or less, more preferably 97 wt % or less, and even more preferably 99 wt % or less.

(Component B) Crosslinking Agent

The resin composition for laser engraving of the present invention preferably comprises (Component B) a crosslinking agent.

In the present invention, the crosslinking agent is not particularly limited. The crosslinking agent may be a compound which bonds with Component A to form a crosslinked structure, or Component B molecules may bond with each other to form a crosslinked structure.

(Component B) the Crosslinking Agent is a Compound Other than Component A.

Component B is preferably a low molecular weight compound. The molecular weight thereof is preferably 100 to 5,000, more preferably 200 to 4,000, even more preferably 300 or more but less than 3,000, and particularly preferably 300 or more but less than 2,000. When the molecular weight is in the range described above, the relief layer thus obtainable has excellent print durability.

In regard to the design of the resin composition for laser engraving, combining a compound having a relatively large molecular weight (Component A) and a compound having a relatively small molecular weight (Component B) is effective for producing a composition which exhibits excellent mechanical properties after curing. When the resin composition is designed only with low molecular weight compounds, the cured product undergoes significant shrinkage, and there is a problem that curing takes a long time. Conversely, when the resin composition is designed only with high molecular weight compounds, curing does not proceed, and a cured product exhibiting excellent physical properties may not be obtained. Therefore, in the present invention, it is preferable to use Component A having a large molecular weight and Component B having a small molecular weight in combination.

Examples of Component B include (Component B-1) a compound having a polymerizable unsaturated group and having a weight average molecular weight of less than 5,000; (Component B-2) a polyfunctional isocyanate compound; and (Component B-3) a compound having a hydrolyzable silyl group and/or a silanol group and having a weight average molecular weight of less than 5,000.

Hereinafter, (Component B-1) to (Component B-3) will be respectively described.

(Component B-1) Compound having polymerizable unsaturated group and having weight average molecular weight of less than 5,000

The resin composition for laser engraving of the present invention preferably comprises (Component B-1) a compound having a polymerizable unsaturated group and having a weight average molecular weight of less than 5,000 (hereinafter, also referred to as Component B-1).

From the viewpoint of the ease of diluting with Component A, the number average molecular weight of Component B-1 is preferably less than 2,000, and preferably 100 or more from the viewpoint of a handling problem such as low volatility.

In the present exemplary embodiment, the content of Component B-1 is not particularly limited, but the content of Component B-1 is preferably at least 20 parts by weight but no greater than 300 parts by weight, and more preferably at least 50 parts by weight but no greater than 250 parts by weight, relative to 100 parts by weight of Component A. When the content of Component B-1 is 20 parts by weight or greater, there is a tendency that the relief printing plate precursor and the relief printing plate, which are cured products of the resin composition, may have sufficient mechanical strength, and when the content is 300 parts by weight or less, there is a tendency that curing shrinkage of the relief printing plate precursor and the relief printing plate, which are cured products of the resin composition, may be reduced.

The polymerizable unsaturated group is preferably a radical polymerizable unsaturated group, more preferably an ethylenically unsaturated group, and even more preferably a (meth)acryloxy group.

Specific examples of Component B-1 include (meth)acrylic acid and derivatives thereof, and (meth)acrylamide and derivatives thereof. From the viewpoints of richness of the kind, cost, and the like, (meth)acrylic acid and derivatives thereof are more preferable.

Examples of the derivatives include an alicyclic compound having a cycloalkyl group, a bicycloalkyl group, a cycloalkene group, a biycloalkene group, or the like; an aromatic compound having a benzyl group, a phenyl group, a phenoxy group, a fluorine group, or the like; a compound having an alkyl group, a halogenated alkyl group, an alkoxyalkyl group, a hydroxyalkyl group, an aminoalkyl group, a glycidyl group, or the like; and an ester compound with a polyhydric alcohol such as an alkylene glycol, a polyoxyalkylene glycol, a polyalkylene glycol, trimethylolpropane, or the like.

One molecule of Component B-1 has at least one polymerizable unsaturated group; more preferably has 2 to 6 polymerizable unsaturated bonding groups; and even more preferably has 2 to 4 polymerizable unsaturated bonding groups.

When the number of polymerizable unsaturated groups in one molecule is in the range described above, excellent crosslinkability with Component A is obtained.

Component B-1 is not particularly limited as long as it is a compound having one or more (meth)acryloxy groups in the molecule, but from the viewpoints of the reaction rate and curing uniformity, Component B-1 has preferably 1 to 10 (meth)acryloxy groups, more preferably 1 to 8 (meth)acryloxy groups, even more preferably 1 to 6 (meth)acryloxy groups, and particularly preferably 2 to 4 (meth)acryloxy groups.

Specific examples of Component B-1 include, for example, (meth)acrylic acid and derivatives thereof.

Examples of derivatives of the compound include a (meth)acrylic acid ester compound having an alicyclic basic structure such as a cycloalkyl group, a bicycloalkyl group, a cycloalkenyl group, a bicycloalkenyl group, or the like; a (meth)acrylic acid ester compound having an aromatic basic structure such as a benzyl group, a phenyl group, a phenoxy group, a fluorenyl group, or the like; a (meth)acrylic acid ester with which an alkyl group, a halogenated alkyl group, an alkoxyalkyl group, a hydroxyalkyl group, an aminoalkyl group, a tetrahydrofurfuryl group, an allyl group, a glycidyl group, or the like is combined; and a (meth)acrylic acid ester of a polyhydric alcohol such as an alkylene glycol, a polyoxyalkylene glycol, an (alkyl/allyloxy)polyalkylene glycol, trimethylolpropane, or the like. Furthermore, a heteroaromatic compound containing a nitrogen atom, a sulfur atom, or the like as a heteroatom may also be used. For example, with regard to a photosensitive resin composition for a printing plate, in order to suppress swelling caused by an organic solvent such as an alcohol or an ester, which is a solvent for printing ink, it is preferable that Component B-1 comprises a compound having a long-chain aliphatic, alicyclic, or aromatic basic structure. Here, the long-chain aliphatic basic structure or alicyclic basic structure may contain a heteroatom, and examples of the heteroatom include an oxygen atom, a sulfur atom, and a nitrogen atom.

Furthermore, in order to increase impact resilience of the printing plate, Component B-1 may be appropriately selected by using known technical knowledge related to photosensitive resins for printing plates (for example, a methacrylic monomer and the like described in JP-A-7-239548).

In the resin composition of the present invention, only one kind of Component B-1 may be used, or two or more kinds of Component B-1 may be used in combination.

(Component B-2) Polyfunctional Isocyanate Compound

In the present invention, (Component B-2) a polyfunctional isocyanate compound may be used as Component B.

The polyfunctional isocyanate compound is not particularly limited as long as it is a compound having two or more isocyanate groups, but preferred examples thereof include diisocyanate compounds having two isocyanate groups.

The diisocyanate compound is preferably a compound represented by Formula (5) below.

OCN-L¹-NCO (5)

wherein in Formula (5), L¹ represents a divalent aliphatic or aromatic hydrocarbon group which may be substituted. According to necessity, L¹ may have another functional group which does not react with an isocyanate group, for example, an ester group, a urethane group, an amide group, or an ureido group.

From the viewpoint of the ease of diluting with Component A, the (number average) molecular weight of Component B-2 is preferably less than 1,000, and from the viewpoint of handleability such as low volatility, the (number average) molecular weight is preferably 100 or greater.

Examples of Component B-2 include an aliphatic diisocyanate compound, an alicyclic diisocyanate compound, an aromatic-aliphatic diisocyanate compound, and an aromatic diisocyanate compound.

Examples of the aliphatic diisocyanate compound include 1,3-trimethylene diisocyanate, 1,4-tetramethylene diisocyanate, 1,3-pentamethylene diisocyanate, 1,5-pentamethylene diisocyanate, 1,6-hexamethylene diisocyanate, 1,2-propylene diisocyanate, 1,2-butylene diisocyanate, 2,3-butylene diisocyanate, 1,3-butylene diisocyanate, 2-methyl-1,5-pentamethylene diisocyanate, 3-methyl-1,5-pentamethylene diisocyanate, 2,4,4-trimethyl-1,6-hexamethylene diisocyanate, 2,2,4-trimethyl-1,6-hexamethylene diisocyanate, 2,6-diisocyanate methyl caproate, and lysine diisocyanate.

Examples of the alicyclic diisocyanate compound include 1,3-cyclopentane diisocyanate, 1,4-cyclohexane diisocyanate, 1,3-cyclohexane diisocyanate, 3-isocyanatomethyl-3,5,5-trimethylcyclohexyl isocyanate, 4,4′-methylenebis(cyclohexyl isocyanate), methyl-2,4-cyclohexane diisocyanate, methyl-2,6-cyclohexane diisocyanate, 1,3-bis(isocyanatomethyl)cyclohexane, 1,4-bis(isocyanatomethyl)cyclohexane, isophorone diisocyaante, and norbornane diisocyanate.

Examples of the aromatic-aliphatic diisocyanate compound include 1,3-xylene diisocyanate, 1,4-xylene diisocyanate, ω,ω′-diisocyanato-1,4-diethylbenzene, 1,3-bis(1-isocyanato-1-methylethyl)benzene, 1,4-bis(1-isocyanato-1-methylethyl)benzene, and 1,3-bis(α,α-dimethylisocyanatomethyl)benzene.

Examples of the aromatic diisocyanate compound include m-phenylene diisocyanate, p-phenylene diisocyanate, 2,4-tolylene diisocyanate, 2,6-tolylene diisocyanate, naphthylene-1,4-diisocyanate, 1,5-naphthalene diisocyanate, 4,4′-diphenyl diisocyanate, 4,4′-diphenylmethane diisocyanate, 2,4′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, and 3,3′-dimethoxydiphenyl-4,4′-diisocyanate.

Examples of Component B-2 include tolylene diisocyanate (TDI), diphenylmethane diisocyanate (MDI), hexamethylene diisocyanate (HDI), isophorone diisocyanate (IPDI), diphenylmethane diisocyanate containing a diphenylmethane diisocyanate dimer compound, carbodiimide-modified diphenylmethane diisocyanate, and urethdione ring and isocyanurate ring-containing modification products of hexamethylene diisocyanate.

Furthermore, Component B-2 may be used individually or in combination.

(Component B-3) Compound Having Weight Average Molecular Weight of Less than 5,000 and Having Hydrolyzable Silyl Group and/or Silanol Group

(Component B-3) Compound having weight average molecular weight of less than 5,000 and having hydrolyzable silyl group and/or silanol group may be used as Component B of the present invention.

The resin composition for laser engraving of the present invention preferably comprises (Component B-3) a compound having a weight average molecular weight of less than 5,000 and having a hydrolyzable silyl group and/or silanol group.

The ‘hydrolyzable silyl group’ of Component B-3 is a silyl group that has a hydrolyzable group; examples of the hydrolyzable group include an alkoxy group, an aryloxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or silanol group is preferably one represented by Formula (1) below.

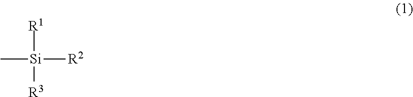

In Formula (1) above, R¹ to R³ independently denote a hydrolyzable group selected from the group consisting of an alkoxy group, an aryloxy group, a mercapto group, a halogen atom, an amide group, an acetoxy group, an amino group, and an isopropenoxy group, a hydroxy group, a hydrogen atom, or a monovalent organic group. In addition, at least one of R¹ to R³ denotes a hydrolyzable group selected from the group consisting of an alkoxy group, an aryloxy group, a mercapto group, a halogen atom, an amide group, an acetoxy group, an amino group, and an isopropenoxy group, or a hydroxy group. A wavy line portion represents a bonding position with other structures.

A preferred organic group in a case where R¹ to R³ represents a monovalent organic group includes an alkyl group having 1 to 30 carbon atoms from the viewpoint of imparting solubility to various organic solvents.

In Formula (1) above, the hydrolyzable group bonded to the silicon atom is particularly preferably an alkoxy group or a halogen atom.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

Component B-3 in the present invention is preferably a compound having one or more groups represented by Formula (1) above, and more preferably a compound having two or more. A compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in the compound is preferably at least 2 but no greater than 6, and most preferably 2 or 3.

A range of 1 to 3 of the hydrolyzable groups may bond to one silicon atom, and the total number of hydrolyzable groups in Formula (1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, and a benzyloxy group. Examples of the alkoxysilyl group having an alkoxy group bonded thereto include a trialkoxysilyl group such as a trimethoxysilyl group, a triethoxysilyl group, a triisopropoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group. A plurality of each of these alkoxy groups may be used in combination, or a plurality of different alkoxy groups may be used in combination.

Specific examples of the aryloxy group include a phenoxy group. Examples of the aryloxysilyl group having an aryloxy group bonded thereto include a triaryloxysilyl group such as a triphenoxysilyl group.

Preferred examples of Component B-3 in the present invention include compounds in which a plurality of groups represented by Formula (1) above are bonded via a linking group, and from the viewpoint of the effects, such a linking group is preferably a linking group having a sulfide group, an imino group or a ureylene group.

The representative synthetic method of Component B-3 containing a linking group having a sulfide group, an imino group or ureylene group is shown below.

<Synthetic Method for Compound Having Hydrolyzable Silyl Group and/or Silanol Group and Having Sulfide Group as Linking Group>

A synthetic method for a Component B-3 having a sulfide group as a linking group (hereinafter, called as appropriate a ‘sulfide linking group-containing Component B-3’) is not particularly limited, but specific examples thereof include reaction of a Component B-3 having a halogenated hydrocarbon group with an alkali metal sulfide, reaction of a Component B-3 having a mercapto group with a halogenated hydrocarbon, reaction of a Component B-3 having a mercapto group with a Component B-3 having a halogenated hydrocarbon group, reaction of a Component B-3 having a halogenated hydrocarbon group with a mercaptan, reaction of a Component B-3 having an ethylenically unsaturated double bond with a mercaptan, reaction of a Component B-3 having an ethylenically unsaturated double bond with a Component B-3 having a mercapto group, reaction of a compound having an ethylenically unsaturated double bond with a Component B-3 having a mercapto group, reaction of a ketone with a Component B-3 having a mercapto group, reaction of a diazonium salt with a Component B-3 having a mercapto group, reaction of a Component B-3 having a mercapto group with an oxirane, reaction of a Component B-3 having a mercapto group with a Component B-3 having an oxirane group, reaction of a mercaptan with a Component B-3 having an oxirane group, and reaction of a Component B-3 having a mercapto group with an aziridine.

<Synthetic Method for Compound Having Hydrolyzable Silyl Group and/or Silanol Group and Having Imino Group as Linking Group>

A synthetic method for a Component B-3 having an imino group as a linking group (hereinafter, called as appropriate an ‘imino linking group-containing Component B-3’) is not particularly limited, but specific examples include reaction of a Component B-3 having an amino group with a halogenated hydrocarbon, reaction of a Component B-3 having an amino group with a Component B-3 having a halogenated hydrocarbon group, reaction of a Component B-3 having a halogenated hydrocarbon group with an amine, reaction of a Component B-3 having an amino group with an oxirane, reaction of a Component B-3 having an amino group with a Component B-3 having an oxirane group, reaction of an amine with a Component B-3 having an oxirane group, reaction of a Component B-3 having an amino group with an aziridine, reaction of a Component B-3 having an ethylenically unsaturated double bond with an amine, reaction of a Component B-3 having an ethylenically unsaturated double bond with a Component B-3 having an amino group, reaction of a compound having an ethylenically unsaturated double bond with a Component B-3 having an amino group, reaction of a compound having an acetylenically unsaturated triple bond with a Component B-3 having an amino group, reaction of a Component B-3 having an imine-based unsaturated double bond with an organic alkali metal compound, reaction of a Component B-3 having an imine-based unsaturated double bond with an organic alkaline earth metal compound, and reaction of a carbonyl compound with a Component B-3 having an amino group.

<Synthetic Method for Compound Having Hydrolyzable Silyl Group and/or Silanol Group and Having Ureylene Group as Linking Group>

A synthetic method for a Component B-3 having an ureylene group (hereinafter, called as appropriate a ‘ureylene linking group-containing Component B-3’) as a linking group is not particularly limited, but specific examples include synthetic methods such as reaction of a Component B-3 having an amino group with an isocyanate ester, reaction of a Component B-3 having an amino group with a Component B-3 having an isocyanate ester, and reaction of an amine with a Component B-3 having an isocyanate ester.

A silane coupling agent is preferably used as Component B-3 in the preset invention.

Hereinafter, the silane coupling agent suitable as Component B-3 in the present invention will be described.

In the present invention, the functional group in which an alkoxy group or a halogeno group (halogen atom) is directly bonded to at least one Si atom is called a silane coupling group, and the compound which has one or more silane coupling groups in the molecule is also called a silane coupling agent. The silane coupling group is preferable in which an alkoxy group or halogen atoms is directly bonded to two or more Si atoms, particularly preferably directly bonded to at least three or more.

In the resin composition of the present invention, if the reactive functional group in Component A is, for example, a hydroxyl group (—OH), at least one of a hydrolyzable silyl group and a silanol group in Component B-3, and preferably a silane coupling group in a silane coupling agent, causes an alcohol-exchange reaction with the hydroxyl group and forms a crosslinked structure. As a result, molecules of the binder polymers are three-dimensionally crosslinked via the silane coupling agent.

The silane coupling agent according to a preferred embodiment of the present invention essentially has at least one functional group selected from an alkoxy group and a halogen atom as a functional group that is directly combined with a Si atom, and from the viewpoint of the ease of handling of the compound, the silane coupling gent preferably has an alkoxy group.

In the silane coupling agent which is a preferable aspect in the present invention, as a functional group directly bonded to the Si atom, it is indispensable to have at least one or more functional groups selected from an alkoxy group and a halogen atom, and one having an alkoxy group is preferable from the viewpoint of ease of handling of the compound.

Here, with regard to the alkoxy group from the viewpoint of rinsing properties and printing durability, an alkoxy group having 1 to 30 carbon atoms is preferable, an alkoxy group having 1 to 15 carbon atoms is more preferable, and an alkoxy group having 1 to 5 carbon atoms is yet more preferable.

Moreover, as a halogen atom, an F atom, a Cl atom, a Br atom, and an I atom are included; from the viewpoint of ease of synthesis and stability, a Cl atom and a Br atom are preferable, and a Cl atom is more preferable.

The silane coupling agent in the present invention preferably contains at least 1 but no greater than 10 of above silane coupling groups within the molecule from the viewpoint of favorably maintaining a balance of the degree of crosslinking of the film and flexibility, more preferably contains at least 1 but no greater than 5, and particularly preferably contains at least 2 but no greater than 4.

When there are two or more of silane coupling groups, it is preferable that silane coupling groups are connected with the linking group each other. As the linking group includes at least a divalent organic group which may have substituents such as a hetero atom and hydrocarbons, from the viewpoint of high engraving sensitivity, an aspect containing hetero atoms (N, S, O) is preferable, and a linking group containing an S atom is particularly preferable.

From these viewpoints, as the silane coupling agent in the present invention, a compound that having in the molecule two silane coupling groups in which the methoxy group or ethoxy group, particulary a methoxy group is bonded to a Si atom as an alkoxy group and these silane coupling groups are bonded through an alkylene group containing a hetero atom (particularly preferably a S atom) is preferable. More specifically, one having a linking group containing a sulfide group is preferable.

Moreover, as another preferred aspect of the linking group connecting together silane coupling groups, a linking group having an oxyalkylene group is included. Since the linking group contains an oxyalkylene group, rinsing properties of engraving residue after laser engraving are improved. As the oxyalkylene group, an oxyethylene group is preferable, and a polyoxyethylene chain in which a plurality of oxyethylene groups are connected is more preferable. The total number of oxyethylene groups in the polyoxyethylene chain is preferably 2 to 50, more preferably 3 to 30, particularly preferably 4 to 15.

Specific examples of the silane coupling agent that can be used in the present invention are shown below. Examples thereof include β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, bis(triethoxysilylpropyl)disulfide, bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-ureidopropyltriethoxysilane. Other than the above, the compounds shown below can be cited as preferred examples, but the present invention should not be construed as being limited thereto.

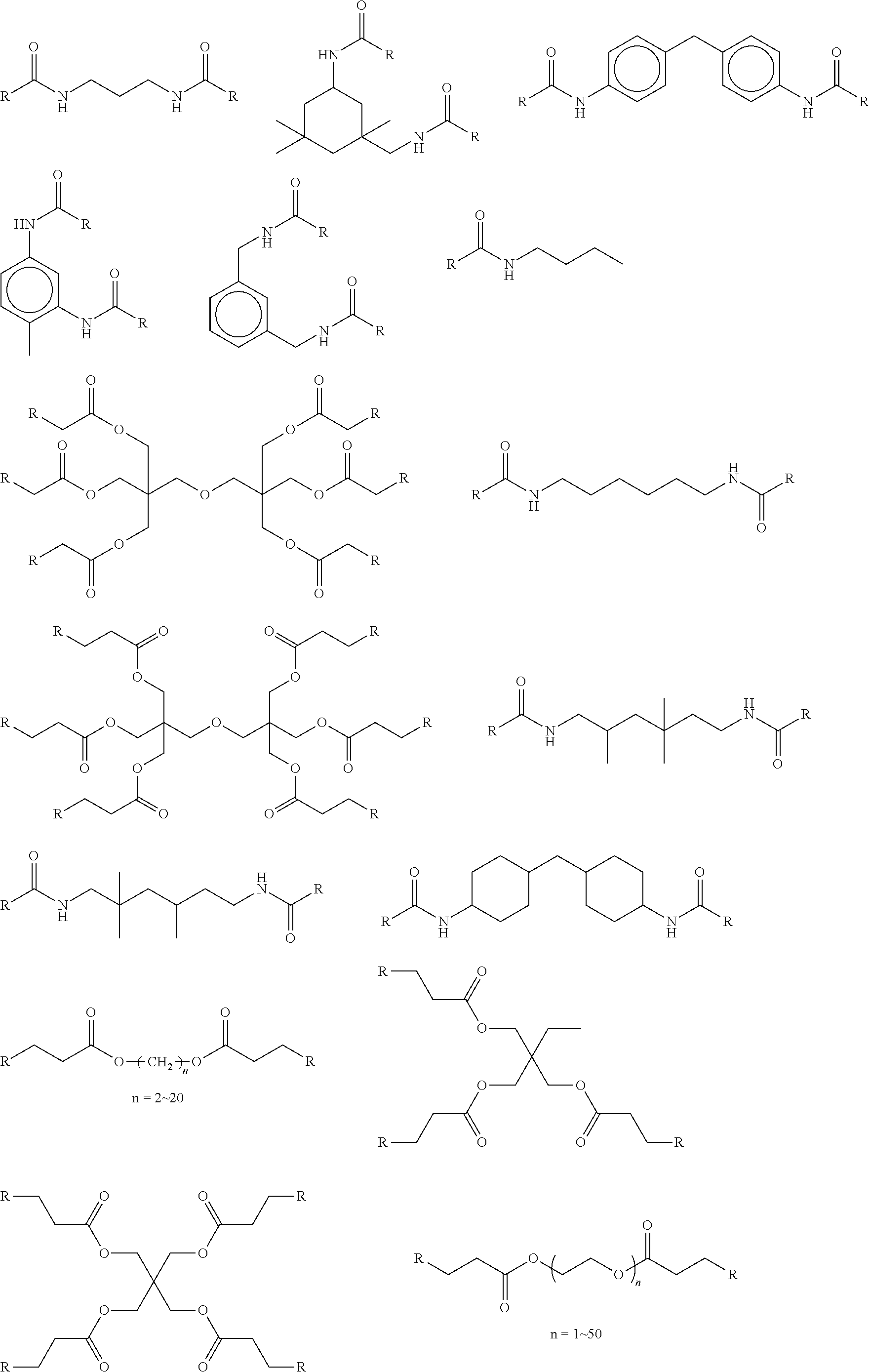

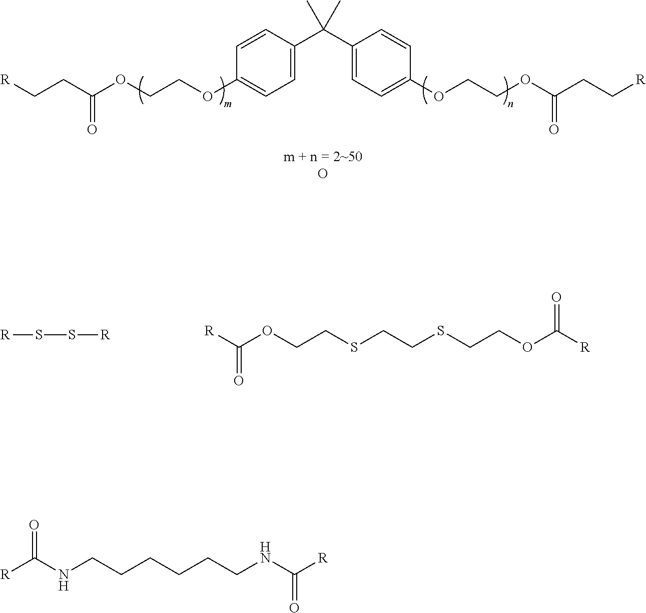

In each of the formulae above, R denotes a partial structure selected from the structures below. When a plurality of Rs and R¹s are present in the molecule, they may be identical to or different from each other, and are preferably identical to each other in terms of synthetic suitability. Et in the chemical formulae below is an ethyl group, and Me is a methyl group.

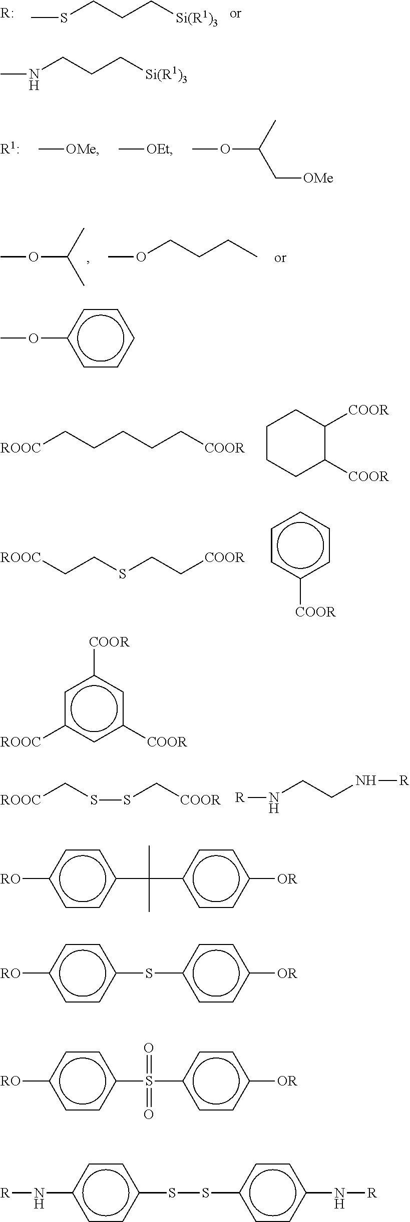

In each of the formulae above, R denotes a partial structure selected from the structures below. R¹ is the same as defined above. When a plurality of Rs and R¹s are present in the molecule, they may be identical to or different from each other, and are preferably identical to each other in terms of synthetic suitability.

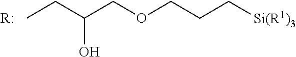

Component B-3 may be obtained by synthesis as appropriate, but use of a commercially available product is preferable in terms of cost. Since Component B-3 corresponds to for example commercially available silane products or silane coupling agents from Shin-Etsu Chemical Co., Ltd., Dow Corning Toray, Momentive Performance Materials Inc., Chisso Corporation, etc., the resin composition of the present invention may employ such a commercially available product by appropriate selection according to the intended application.

As the silane coupling agent in the present invention, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Specific examples of such a partial (co)hydrolysis-condensation product include a partial (co)hydrolysis condensaste obtained by using, as a precursor, one or more selected from the group of silane compounds consisting of alkoxysilanes or acetyloxysilanes such as tetramethoxysilane, tetraethoxysilane, methyltrimethoxysilane, methyltriethoxysilane, methyltriisopropoxysilane, methyltriacetoxysilane, methyltris(methoxyethoxy)silane, methyltris(methoxypropoxy)silane, ethyltrimethoxysilane, propyltrimethoxysilane, butyl trimethoxysilane, hexyltrimethoxysilane, octyltrimethoxysilane, decyltrimethoxysilane, cyclohexyltrimethoxysilane, phenyltrimethoxysilane, phenyltriethoxysilane, tolyltrimethoxysilane, chloromethyltrimethoxysilane, γ-chloropropyltrimethoxysilane, 3,3,3-trifluoropropyltrimethoxysilane, cyanoethyltriethoxysilane, γ-glycidoxypropyltrimethoxysi lane, γ-glycidoxypropyltriethoxysilane, β-(3,4-epoxycyclohexyl)ethyltrimethoxysilane, γ-aminopropyltrimethoxysilane, γ-aminopropyltriethoxysilane, N-β(aminoethyl)-γ-aminopropyltrimethoxysilane, N-phenyl-γ-aminopropyltrimethoxysilane, γ-mercaptopropyltrimethoxysilane, dimethyldimethoxysilane, dimethyldiethoxysilane, diethyldimethoxysilane, methylethyldimethoxysilane, methylpropyldimethoxysilane, diphenyldimethoxysilane, diphenyldiethoxysilane, methylphenyldimethoxysilane, γ-chloropropylmethyldimethoxysilane, 3,3,3-trifluoropropylmethyldimethoxysilane, γ-glycidoxypropylmethyldiethoxysilane, γ-aminopropylmethyldiethoxysilane, N-β-(aminoethyl)-γ-aminopropylmethyldimethoxysilane and γ-mercaptopropylmethyldiethoxysilane, and an acyloxysilane such as ethoxalyloxysilane.

Among silane compounds as partial (co)hydrolysis-condensation product precursors, from the viewpoint of versatility, cost, and film compatibility, a silane compound having a substituent selected from a methyl group and a phenyl group as a substituent on the silicon is preferable. Specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is preferable to use a dimer (2 moles of silane compound is reacted with 1 mole of water to eliminate 2 moles of alcohol, thus giving a disiloxane unit) of the silane compounds cited above to 100-mer of the above-mentioned silane compound, more preferably a dimer to 50-mer, and yet more preferably a dimer to 30-mer, and it is also possible to use a partial (co)hydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

Regarding Component B-3 in the resin composition of the present invention, only one kind may be used, or two or more kinds may be used in combination.

The content of Component B-3 included in the resin composition of the present invention is, in terms of solid content, preferably in the range of 0.1 wt % to 80 wt %, more preferably in the range of 1 wt % to 40 wt %, and most preferably 5 wt % to 30 wt %.

In the present invention, regarding Component B, only one kind may be used, or two or more kinds may be used in combination.

The content of Component B in the resin composition is preferably 0.1 wt % to 80 wt %, more preferably 1 wt % to 60 w %, and even more preferably 5 wt % to 40 wt %, relative to the total solid content. When the content of Component B is in the range described above, a relief-forming layer having excellent rupture properties and excellent print durability may be obtained.

In the present invention, examples of preferred combinations of Component A and Component B include the following combinations 1 to 7.

1. Component A: a polymer having ethylenically unsaturated groups at the main chain ends, Component B: a (meth)acrylate compound

2. Component A: a polymer having ethylenically unsaturated groups at the main chain ends, Component B: a silane coupling agent

3. Component A: a polymer having hydroxyl groups at the main chain ends, Component B: a (meth)acrylate compound)

4. Component A: a polymer having hydroxyl groups at the main chain ends, Component B: a polyfunctional isocyanate compound

5. Component A: a polymer having hydroxyl groups at the main chain ends, Component B: a silane coupling agent

6. Component A: a polymer having alkoxysilyl groups at the main chain ends, Component B: a (meth)acrylate compound

7. Component A: a polymer having alkoxysilyl groups at the main chain ends, Component B: a silane coupling agent

In the present invention, among the combinations of Component A and Component B, the combination of 1 or the combination of 5 is particularly preferable because the combination can give a resin composition having excellent crosslinkability.

A (meth)acrylate compound and a silane coupling agent are capable of curing a relief-forming layer by a crosslinking reaction caused between crosslinking agents. Therefore, when Component B is a (meth)acrylate compound or a silane coupling agent, reactivity between Component A and Component B is not necessary needed. On the other hand, when Component B is a polyfunctional isocyanate compound, Component A needs a group which is reactive with an isocyanate group. In the combination of 4, a hydroxyl group reacts with an isocyanate group to form a crosslinked structure.

The ratio of contents of Component A and Component B in the resin composition is such that the ratio of Component A:Component B (weight ratio) is preferably 90:10 to 10:90, more preferably 80:20 to 20:80, and even more preferably 60:40 to 40:60.

Hereinafter, various components that may be comprised in the resin composition of the present invention in addition to Component A and Component B will be described.

### <(Component C) Photothermal Conversion Agent>

The resin composition for laser engraving of the present invention preferably comprises (Component C) a photothermal conversion agent. It is surmised that the photothermal conversion agent absorbs laser light and generates heat thus promoting thermal decomposition of a cured material of the resin composition for laser engraving of the present invention during laser engraving. Because of this, it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 nm to 1,300 nm is used as a light source for laser engraving, it is preferable for the relief-forming layer in the present invention to comprise a photothermal conversion agent that can absorb light having a wavelength of 700 nm to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 nm to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, phthalocyanine-based colorants, and dyes described in paragraphs 0124 to 0137 of JP-A-2008-63554 are preferably used.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples include pigments described in paragraphs 0122 to 0125 of JP-A-2009-178869. Among these pigments, carbon black is preferable.

Any carbon black, regardless of classification by ASTM (American Society for Testing and Materials) and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance of using, as necessary, a dispersant, and such chips and paste are readily available as commercial products. Examples include carbon black include described in paragraphs 0130 to 0134 in JP-A-2009-178869.

With regard to Component C in the resin composition, one type may be used on its own, or two or more types may be used in combination.

The content of the photothermal conversion agen in the resin composition for laser engraving greatly varies depending on the molecular extinction coefficient inherent to the molecule, and, relative to the total solid content of the resin composition, 0.01 to 30 wt % is preferable, 0.05 to 20 wt % is more preferable, and 0.1 to 10 wt % is particularly preferable.

The resin composition for laser engraving of the present invention may comprise inorganic particles.

Examples of the inorganic particles include silica particles, titania particles, porous particles and poreless particles.

### <Silica Particles>

The resin composition for laser engraving of the present invention preferably comprises silica particles.

According to the present invention, it is preferable for the silica particles that the number average particle size is 0.01 μm or more and 10 μm or less. When the number average particle size is in the range described above, tackiness can be reduced, the effect on the surface roughness of the printing plate precursor is small, and pattern formation by laser engraving is enabled without any defects occurring in printed images. Furthermore, it is preferable that the silica particles are porous fine particles or poreless ultrafine particles.

The number average particle size of silica particles is preferably 0.01 μm to 10 μm, more preferably 0.5 μm to 8 μm, and even more preferably 1 μm to 5 μm.

Here, the number average particle size of the particles means an average value of the values of the major axis measured by microscopic observation. Specifically, the magnification is adjusted such that at least about 50 particles fit in the visual field of the microscope, and the major axes of the particles are measured. It is preferable to use a microscope having a measuring function, but the dimension may also be measured based on an image taken using a camera.

### <Porous Particles>

The porous particles are defined as particles having fine pores which have a fine pore volume of 0.1 ml/g or greater, or particles having fine voids. As the resin composition includes porous particles, when the surface of the relief-forming layer is made to have a desired surface roughness, processing is facilitated. Examples of the processing include cutting, grinding, or polishing. The tackiness of the residue and the like occurring during the processing at the time of obtaining a desired surface roughness by the porous particles is reduced, and precision processing of the relief-forming layer surface is facilitated.

The porous particles are preferably such that the specific surface area is 10 m²/g or more and 1,500 m²/g or less, the average fine pore diameter is 1 nm or more and 1,000 nm or less, the fine pore volume is 0.1 ml/g or more and 10 ml/g or less, and the oil absorption is 10 ml/100 g or more and 2,000 ml/100 g or less. The specific surface area can be determined based on the BET equation from an adsorption isotherm of nitrogen at −196° C. Furthermore, in the measurement of the fine pore volume and the average fine pore diameter, a nitrogen adsorption method is used. The measurement of the oil absorption is carried out according to JIS-K5101. When the specific surface area of the porous particles is in the range described above, for example, in the case of forming image areas by engraving using a laser on a printing plate precursor, it is suitable for absorbing decomposition products that have been removed.

The number average particle size of the porous particles is preferably 0.01 μm or more and 10 μm or less. The number average particle size is more preferably 0.5 μm or more and 8 μm or less, and yet more preferably 1 μm or more and 5 μm or less. When the number average particle size is in the range described above, tackiness in the cutting, grinding and polishing processes can be reduced, the effect on the surface roughness of the printing plate precursor is small, and pattern formation by laser engraving is enabled without any defects occurring in printed images.

The shape of the porous particles is not particularly limited, and particles having a spherical shape, a flat shape or a needle shape, amorphous particles, or particles having protrusions on the surface can be used. Particularly, from the viewpoint of wear resistance, it is preferable that at least 70% of the particles are spherical particles having a true sphericity in the range of from 0.5 to 1.

As an index defining the degree of sphericity of the porous particles, the true sphericity is defined. The true sphericity according to the present invention is defined as the ratio of the maximum value D₁ of a circle which, when the image of a porous particle is projected, completely fits in the projected figure, and the minimum value D₂ of a circle in which the projected figure completely fits in (D₁/D₂). In the case of a true sphere, the true sphericity is 1.0. The true sphericity of the porous fine particle is preferably 0.5 or more and 1.0 or less, and more preferably 0.7 or more and 1.0 or less. When the true sphericity is 0.5 or greater, wear resistance as in a printing plate is satisfactory. A true sphericity of 1.0 is the upper limit of the true sphericity. As for the porous particles, preferably 70% or more, and more preferably 90% or more, of the porous particles have a true sphericity of 0.5 or greater. As a method for measuring the true sphericity, a method of making measurement based on a photograph taken using a scanning electron microscope can be used. In that case, it is preferable to take photographs at a magnification at which at least 100 or more particles fit in the monitor screen. Furthermore, although the values of D₁ and D₂ are measured based on a photograph, it is preferable to process the photograph using an apparatus which digitalizes photographs, such as a scanner, and then processing the data using an image analysis software.

Furthermore, it is also possible to use particles having cavities inside the particles, or spherical granules having a uniform fine pore diameter, such as silica sponge. Although not particularly limited, examples include porous silica, mesoporous silica, silica-zirconia porous gel, and porous glass. Furthermore, as in the case of layered clay compounds, since the fine pore diameter cannot be defined in materials in which voids having a size of several nanometers (nm) to several hundred nanometers (nm) are present between layers, according to the present invention, the interval of the voids present between the layers is defined as the fine pore diameter.

Furthermore, the surfaces of the porous particles are coated with a silane coupling agent, a titanate coupling agent or another organic compound to perform a surface modification treatment, and thus further hydrophilized or hydrophobized particles can also be used. One kind or two or more kinds of these porous particles can be selected.

### <Poreless Particles>

The poreless particles are defined as particles having a fine pore volume of less than 0.1 ml/g. The number average particle size of the poreless particles is the number average particle size directed to primary particles, and is preferably 10 nm or more and 500 nm or less, and more preferably least 10 nm or more and 100 nm or less. When the number average particle size is in this range, tackiness in the cutting, grinding and polishing processes can be reduced, the effect of the poreless particles on the surface roughness of the relief printing plate precursor is small, and pattern formation by laser engraving is enabled without any defects occurring in the printed images.

The content of inorganic particles in the resin composition for laser engraving of the present invention is not particularly limited, but the content is preferably in the range of 1 to 30 wt %, more preferably in the range of 3 to 20 wt %, and most preferably 5 to 15 wt %, relative to the total solids content.

When the content of inorganic particles is within the range described above, the effect on the surface roughness of the printing plate precursor is small, and tackiness can be reduced without any defects occurring in the printed images, which is preferable.

The resin composition for lazer engraving of the present invention may comprises various additives described below as an optional component.

### <Alcohol Exchange Reaction Catalyst>

The resin composition for lazer engraving of the present invention preferably comprises an alcohol exchange reaction catalyst.

The alcohol exchange reaction catalyst means a compound that accelerates the reaction between an alkoxy silyl group of Component A and a hydroxy group. Preferred examples of the alcohol exchange reaction catalyst includes an acidic catalyst or basic catalyst, and a metal complex catalyst.

The alcohol exchange reaction catalyst may preferably be used together with Component A having an alkixy silyl group, and/or Component B-3.

The type of the alcohol exchange reaction catalyst is not limited, and examples of the alcohol exchange reaction catalyst include organic acids and inorganic acids, organic bases and inorganic bases, and salts thereof.

Examples of the organic or inorganic acids include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, heteropoly acid, inorganic solid acid etc. Among these, methanesulfonic acid, p-toluenesulfonic acid, dodecylbenzenesulfonic acid, phosphoric acid, phosphonic acid and acetic acid are preferable, and, from the viewpoint of the film strength after the thermal crosslinking, methanesulfonic acid, p-toluenesulfonic acid and phosphoric acid are particularly preferable.

Examples of the organic bases and inorganic bases, and salts thereof include tertiary amines and imidazoles, inorganic bases, quaternary ammonium salts, and quaternary phosphonium salts.

Examples of the tertiary amines and imidazoles include trimethylamine, triethylamine, tripropylamine, tributylamine, tripentylamine, trihexylamine, dimethylethylamine, dimethylpropylamine, dimethylbutylamine, dimethylpentylamine, dimethylhexylamine, diethylpropylamine, diethylbutylamine, diethylpentylamine, diethylhexylamine, dipropylbutylamine, dipropylpentylamine, dipropylhexylamine, dibutylpentylamine, dibutylhexylamine, dipentylhexylamine, methyldiethylamine, methyldipropylamine, methyldibutylamine, methyldipentylamine, methyldihexylamine, ethyldipropylamine, ethyldibutylamine, ethyldipentylamine, ethyldihexylamine, propyldibutylamine, propyldipentylamine, propyldihexylamine, butyldipentylamine, butyldihexylamine, pentyldihexylamine, methylethylpropylamine, methylethylbutylamine, methylethylhexylamine, methylpropylbutylamine, methylpropylhexylamine, ethylpropylbutylamine, ethylbutylpentylamine, ethylbutylhexylamine, propylbutylpentylamine, propylbutylhexylamine, butylpentylhexylamine, trivinylamine, triallylamine, tributenylamine, tripentenylamine, trihexenylamine, dimethylvinylamine, dimethylallylamine, dimethylbutenylamine, dimethylpentenylamine, diethylvinylamine, diethylallylamine, diethylbutenylamine, diethylpentenylamine, diethylhexenylamine, dipropylvinylamine, dipropylallylamine, dipropylbutenylamine, methyldivinylamine, methyldiallylamine, methyldibutenylamine, ethyldivinylamine, ethyldiallylamine, tricyclopentylamine, tricyclohexylamine, tricyclooctylamine, tricyclopentenylamine, tricyclohexenylamine, tricyclopentadienylamine, tricyclohexadienylamine, dimethylcyclopentylamine, diethylcyclopentylamine, dipropylcyclopentylamine, dibutylcyclopentylamine, dimethylcyclohexylamine, diethylcyclohexylamine, dipropylcyclohexylamine, dimethylcyclopentenylamine, diethylcyclopentenylamine, dipropylcyclopentenylamine, dimethylcyclohexenylamine, diethylcyclohexenylamine, dipropylcyclohexenylamine, methyldicyclopentylamine, ethyldicyclopentylamine, propylcyclopentylamine, methyldicyclohexylamine, ethyldicyclohexylamine, propylcyclohexylamine, methyldicyclopentenylamine, ethyldicyclopentenylamine, propyldicyclopentenylamine, N,N-dimethylaniline, N,N-dimethylbenzylamine, N,N-dimethyltoluidines, N,N-dimethylnaphthylamines, N,N-diethylaniline, N,N-diethylbenzylamine, N,N-diethyltoluidine, N,N-diethylnaphthylamine, N,N-dipropylaniline, N,N-dipropylbenzylamine, N,N-dipropyltoluidine, N,N-dipropylnaphthylamine, N,N-divinylaniline, N,N-diallylaniline, N,N-divinyltoluidine, diphenylmethylamine, diphenylethylamine, diphenylpropylamine, dibenzylmethylamine, dibenzylethylamine, dibenzylcyclohexylamine, dibenzylvinylamine, dibenzylallylamine, ditolylmethylamine, ditolylethylamine, ditolylcyclohexylamine, ditolylvinylamine, triphenylamine, tribenzylamine, tri(tolyl)amine, trinaphthylamine, N,N,N′,N′-tetramethylethylenediamine, N,N,N′,N′-tetraethylethylenediamine, N,N,N′,N′-tetramethyltolylenediamine, N,N,N′,N′-tetraethyltolylenediamine, N-methylpyrrole, N-methylpyrrolidine, 2-ethyl-4-methylimidazole, 2-phenylimidazole, 1-(2-cyanoethyl)-2-ethyl-4-methylimidazole, 2-phenylimidazoline, N,N′-dimethylpiperazine, N-methylpiperidine, N-ethylpyrrole, N-methylpyrrolidine, N-ethylimidazole, N,N′-diethylpiperazine, N-ethylpiperidine, pyridine, pyridazine, pyrazine, quinoline, quinazoline, quinuclidine, N-methylpyrrolidone, N-methylmorpholine, N-ethylpyrrolidone, N-ethylmorpholine, N,N-dimethylanisole, N,N-diethylanisole, N,N-dimethylglycine, N,N-diethylglycine, N,N-dimethylalanine, N,N-diethylalanine, N,N-dimethylethanolamine, N,N-dimethylaminothiophene, 1,1,3,3-tetramethylguanidine, 1,8-diazabicyclo[5.4.0]undeca-7-ene, 1,5-diazabicyclo[4.3.0]nona-5-ene, 1,4-diazabicyclo[2.2.2]octane and hexamethylenetetramine etc.

From the viewpoint of the film strength after the thermal crossliniking, 2-ethyl-4-methylimidazole, 2-phenylimidazole, 1-(2-cyanoethyl)-2-ethyl-4-methylimidazole, 2-phenylimidazoline, 1,8-diazabicyclo[5.4.0]undeca-7-ene, 1,5-diazabicyclo[4.3.0]nona-5-ene and 1,1,3,3-tetramethylguanidine are preferable, and 2-ethyl-4-methylimidazole, 2-phenylimidazole, 1,8-diazabicyclo[5.4.0]undeca-7-ene and 1,5-diazabicyclo[4.3.0]nona-5-ene are particularly preferable.

Examples of the inorganic bases include alkali metal hydroxides, alkali metal alkoxides and alkaline earth metal oxides. Among these, sodium t-butoxide, potassium t-butoxide, sodium methoxide, potassium methoxide, sodium ethoxide and potassium ethoxide are preferable, sodium t-butoxide, potassium t-butoxide, sodium ethoxide and potassium ethoxide are more preferable.

Examples of the quaternary ammonium salts include tetramethylammonium bromide, tetraethylammonium bromide, tetrabutylammonium bromide, tetramethylammonium bromide, benzyltrimethylammonium chloride, benzyltrimethylammonium bromide, decyltrimethylammonium chloride and decyltrimethylammonium bromide, etc. Among these, tetramethylammonium bromide, tetraethylammonium bromide and tetrabutylammonium bromide are preferable, and tetraethylammonium bromide is more preferable.

Examples of the quaternary phosphonium salts include tetramethylphosphonium bromide, tetraethylphosphonium bromide, tetrabutylphosphonium bromide, tetramethylphosphonium bromide, benzyltrimethylphosphonium chloride, benzyltrimethylphosphonium bromide, decyltrimethylphosphonium chloride and decyltrimethylphosphonium bromide. Among these, tetramethylphosphonium bromide, tetraethylphosphonium bromide and tetrabutylphosphonium bromide are preferable, and tetraethylphosphonium bromide is more preferable.

In regard to the basic compounds and acidic compounds, it is preferable to use a basic compound because the reaction proceeds smoothly.

One kind of alcohol exchange reaction catalyst may be used, and two or more kinds thereof may also be used in combination. The content is not particularly limited, and may be appropriately selected according to the characteristics of compound having a hydrolyzable silyl group and/or silanol group, and the like that are used.

### <Radical Polymerization Initiator>

The resin composition for laser engraving of the present invention preferably comprises a radical polymerization initiator.

The radical polymerization initiator is not particularly limited and a known radical polymerization initiator may be used without particular limitations.

In the present invention, preferable radical polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the relief printing plate precursor, from the viewpoint of engraving sensitivity and making a favorable relief edge shape, (c) organic peroxides and (l) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (l) azo compounds are preferably include the following compounds.

### (c) Organic Peroxides

Preferable (c) organic peroxides as a radical polymerization initiator that can be used in the present invention include preferably a peroxide ester such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone and di-t-butyldiperoxyisophthalate, t-butyl peroxybenzoate, t-butyl peroxy-3-methyl benzoate, t-butylperoxylaurate, t-butyl peroxypivalate, t-butylperoxy-2-ethylhexanoate, t-butylperoxy-3,5,5-trimethylhexanoate, t-butylperoxyneoheptanoate, t-butyl peroxyneodecanoate, t-butylperoxyacetate, and preferably α,α′-di(t-butylperoxy)diisopropylbenzene, t-butylcumylperoxide, di-t-butylperoxide, t-butylperoxyisopropylmonocarbonate, t-butylperoxy-2-ethylhexylmonocarbonate, and from the view point of thermal degradation characteristics, t-butylperoxybenzoate is more preferable.

### (l) Azo Compounds

Preferable (l) azo compounds as a radical polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

In addition, in the present invention, the (c) organic peroxides as a polymerization initiator of the invention are preferable from the viewpoint of crosslinking property of the film (relief-forming layer), furthermore, as an unexpected effect, a particularly preferable effect was found from the viewpoint of the improvement in engraving sensitivity.

The content of the radical polymerization initiator in the resin composition for laser engraving is preferably 0.01 to 10 wt %, and more preferably 0.1 to 3 wt %, relative to the total solids content. When the content of the radical polymerization initiator is set to 0.01 wt % or more, the effect of adding this compound may be obtained, and the crosslinking of the crosslinkable relief-forming layer occurs rapidly. Further, when the content is set to 10 wt % or less, the other components do not lack, and sufficient printing durability for the use as a relief printing plate can be obtained.

### <Plasticizer>

The resin composition for laser engraving of the present invention may comprise a plasticizer. Meanwhile, in the present invention, since the resin composition comprises Component A and thus a relief layer obtained has excellent flexibility, a plasticizer may not be added.

Since the plasticizer in the present invention is a compound having an action of softening a film formed by the resin composition for laser engraving, it is necessary that the plasticizer have good compatibility with the binder polymer.

Examples of the plasticizer preferably used include dioctyl phthalate, didodecyl phthalate, bisbutoxyethyl adipate, polyethylene glycols, polypropylene glycol (monool type or diol type), and polypropylene glycol (monool type or diol type).

Among these, bisbutoxyethyl adipate is particularly preferable.

Regarding the plasticizer in the resin composition of the present invention, only one kind may be used, or two or more kinds may be used in combination.

From the viewpoint of maintaining flexible film properties, the content of the plasticizer in the resin composition for laser engraving of the present invention is preferably 50 wt % or less, more preferably 30 wt % or less, and even more preferably 10 wt % or less, relative to the total solid concentration, and it is particularly preferable that no plasticizer is added.

### <Solvent>

When the resin composition for laser engraving of the present invention is prepared, it is preferable to use a solvent.

As the solvent, it is preferable to use an organic solvent.

Preferred examples of an aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Preferred examples of a protic organic solvent include methanol, ethanol, 1-propanol, 2-propanol, 1-butanol, 1-methoxy-2-propanol, ethylene glycol, diethylene glycol, and 1,3-propanediol.

Among these, propylene glycol monomethyl ether acetate is particularly preferable.

### <Other Additives>

The resin composition for laser engraving of the present invention may comprise as appropriate various types of known additives as long as the effects of the present invention are not inhibited. Examples include a filler, a wax, a process oil, a metal oxide, an antiozonant, an anti-aging agent, a thermopolymerization inhibitor, and a colorant, and one type thereof may be used on its own or two more types may be used in combination.

### (Flexographic Printing Plate Precursor for Laser Engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

Flexographic printing plate precursor for laser engraving of the present invention preferably comprises a crosslinked relief-forming layer crosslinked by heat.

In the present invention, the ‘flexographic printing plate precursor for laser engraving’ means both or one of a plate having a crosslinkable relief-forming layer formed from the resin composition for laser engraving in a state before being crosslinked and a plate in a state in which it is cured by light and/or heat.

In the present invention, the ‘relief-forming layer’ means a layer in a state before being crosslinked, that is, a layer formed from the resin composition for laser engraving of the present invention, which may be dried as necessary.

In the present invention, the ‘crosslinked relief-forming layer’ means a layer formed by crosslinking the relief-forming layer. The crosslinking is preferably carried out by means of light and/or heat. Furthermore, the crosslinking is not particularly limited as long as it is a reaction by which the resin composition is cured, and it is a concept that includes a structure crosslinked due to reactions among Component A's, but it may preferably form a crosslinked structure by a reaction between Component A and another Component. When a polymerizable compound is used, the crosslinking comprises a crosslinking formed by polymerization of the polymerizable compound.

The ‘flexographic printing plate’ is prepared by laser engraving a printing plate precursor having a crosslinked relief-forming layer.

Moreover, in the present invention, the ‘relief layer’ means a layer of the relief printing plate formed by engraving using a laser, that is, the crosslinked relief-forming layer after laser engraving.

A flexographic printing plate precursor for laser engraving of the present invention comprises a relief-forming layer formed from the resin composition for laser engraving of the present invention, which comprises the above-mentioned components. The (crosslinked) relief-forming layer is preferably provided on or above a support.

The (crosslinked) flexographic printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention and is preferably a heat-crosslinkable layer.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

A case in which the relief-forming layer is mainly formed in a sheet shape is explained as an example below.

### <Support>

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Flexographic Printing Plate Precursor for Laser Engraving)

Formation of a relief-forming layer in the flexographic printing plate precursor for laser engraving is not particularly limited, and examples thereof include a method in which the resin composition for laser engraving is prepared, solvent is removed as necessary from this resin composition for laser engraving, and it is melt-extruded onto a support. Alternatively, a method may be employed in which the resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of light and/or heat to thus obtain a flexographic printing plate precursor having a crosslinked relief-forming layer, and more preferably a production process comprising a layer formation step of forming a relief-forming layer from the resin composition for laser engraving of the present invention and a crosslinking step of crosslinking the relief-forming layer by means of heat to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for making the relief printing plate precursor for laser engraving of the present invention preferably comprises a layer formation step of forming a relief-forming layer from the resin composition for laser engraving of the present invention.

Preferred examples of a method for forming a relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove the solvent.

The resin composition for laser engraving may be produced by, for example, dissolving Component A, and an optional components in an appropriate solvent.

The thickness of the (crosslinked) relief-forming layer in the flexographic printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

### <Crosslinking Step>

The process for producing a flexographic printing plate precursor for laser engraving of the present invention is preferably a production process comprising a crosslinking step of crosslinking the relief-forming layer by means of light and/or heat to thus obtain a flexographic printing plate precursor having a crosslinked relief-forming layer.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

When the relief-forming layer comprises a thermopolymerization initiator (it being possible for the above-mentioned photopolymerization initiator to function also as a thermopolymerization initiator), the relief-forming layer may be crosslinked by heating the flexographic printing plate precursor for laser engraving (step of crosslinking by means of heat). As heating means, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of the general properties of a material, the lower the molecular weight, the more easily it becomes a liquid rather than a solid, that is, there is a tendency for tackiness to be stronger. Engraving residue formed when engraving a relief-forming layer tends to have higher tackiness the more that low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and azo group-containing compound. A representative vulcanizing agent may also be used for crosslinking. Thermal crosslinking may also be carried out by adding a heat-curable resin such as for example an epoxy resin as a crosslinking component to a layer.

### (Flexographic Printing Plate and Process for Making Same)

The process for making a flexographic printing plate of the present invention preferably comprises an engraving step of laser-engraving a crosslinked flexographic layer of a flexographic printing plate precursor of the present invention. In detail the process for making a flexographic printing plate preferably comprises step of preparing a flexographic printing plate precursor which has been produced by (1) a layer formation step of applying, on a support, a resin composition comprising (Component A) a polymer that has a constituent unit derived from an ethylenically unsaturated monomer, has at least two functional groups selected from the group consisting of an ethylenically unsaturated group, a hydroxyl group and an alkoxysilyl group at the main chain ends, and has a molecular weight dispersity (Mw/Mn) of at least 1.0 but no greater than 1.6, and a curing step (2) of thermally curing the resin composition, and a step of laser-engraving the flexographic printing plate precursor.

The above process for making a flexographic printing plate preferably comprises subsequently to the steps (1) and (2), a step of providing a photocurable composition layer on the surface of the thermally cured resin composition, a step of pasting another light-transmissive support on the photocurable composition layer, and a step of photo-curing the photocurable composition.

The curing step (2) of thermally curing step is a step of crosslinking the relief-forming layer by means of heat to thus obtain a flexographic printing plate precursor having a crosslinked relief-forming layer. The step of laser-engraving is to engrave the flexographic printing plate precursor having the crosslinked relief-forming layer. The process for making a flexographic printing plate, preferably comprises a step of forming a relief-forming layer from the resin composition for laser engraving of the present invention, a step of crosslinking the relief-forming layer by means of heat to thus obtain a flexographic printing plate precursor having a crosslinked relief-forming layer, and an step of laser-engraving the flexographic printing plate precursor having the crosslinked relief-forming layer.

The flexographic printing plate of the present invention is a flexographic printing plate having a relief layer obtained by crosslinking and laser-engraving a layer formed from the resin composition for laser engraving of the present invention, and is preferably a flexographic printing plate made by the process for producing a flexographic printing plate of the present invention.

The flexographic printing plate of the present invention may suitably employ an aqueous ink when printing.

The layer formation step and the crosslinking step in the process for producing a flexographic printing plate of the present invention mean the same as the layer formation step and the crosslinking step in the above-mentioned process for producing a flexographic printing plate precursor for laser engraving, and preferred ranges are also the same.

### <Engraving Step>

The process for making a flexographic printing plate of the present invention preferably comprises an engraving step of laser-engraving the relief printing starting plate having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is further preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, and ‘Applied Laser Technology’ The Institute of Electronics and Communication Engineers, etc.

Moreover, as plate making equipment comprising a fiber-coupled semiconductor laser that can be used suitably in the process for making a relief printing plate employing the relief printing starting plate of the present invention, those described in detail in JP-A-2009-172658 and JP-A-2009-214334 can be cited.

The process for making a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid containing water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid containing water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin relief printing starting plate, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, yet more preferably no greater than 13.2. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, amphoteric surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 weight % relative to the total weight of the rinsing liquid, and more preferably 0.05 to 10 weight %.

The flexographic printing plate of the present invention having a relief layer on the surface of any substrate such as a support etc. may be produced as described above.

From the viewpoint of satisfying suitability for various aspects of printing, such as abrasion resistance and ink transfer properties, the thickness of the relief layer of the relief printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target so as to deform it, measures the amount of deformation (indentation depth), and converts it into a numerical value.

The flexographic printing plate of the present invention is particularly suitable for printing by a flexographic printer using an aqueous ink, but printing is also possible when it is carried out by a relief printer using any of aqueous, oil-based, and UV inks, and printing is also possible when it is carried out by a flexographic printer using a UV ink. The relief printing plate of the present invention has excellent rinsing properties, there is no engraving residue, since a relief layer obtained has excellent elasticity aqueous ink transfer properties and printing durability are excellent, and printing can be carried out for a long period of time without plastic deformation of the relief layer or degradation of printing durability.

According to the present invention, a resin composition for laser engraving from which a flexographic printing plate having an excellent strength of the relief layer and an excellent print durability, a flexographic printing plate precursor using the resin composition for a flexographic printing plate, a process for producing the flexographic printing plate precursor, a flexographic printing plate, and a process for making the flexographic printing plate, may be provided.

### EXAMPLES

The present invention is explained in further detail below by reference to Examples and Comparative Examples, but the present invention should not be construed as being limited to these Examples. Furthermore, ‘parts’ in the description below means ‘parts by weight’, and ‘%’ means ‘% by weight’, unless otherwise specified.

Moreover, the number-average molecular weight (Mn) of a polymer in the Examples are values measured by a GPC method unless otherwise specified.

Syntheses of Polymer 1 to 6, and Comparative Polymer R1 to R3 are explained below.

### <Synthesis of Polymer 1>

Synthesis was carried out by using the synthesis method described in Example of Japanese Patent No. 3639859 and using 1,4-bis(2-thiobenzoylthioprop-2-yl)benzene as a RAFT agent and n-butyl acrylate as an olefinic unsaturated monomer. The polymer obtained was subjected to a polymer end treatment by means of a radical initiator, VA-086 (2,2′-azobis[2-methyl-N-(2-hydroxyethyl)propionamide]), manufactured by Wako Pure Chemical Industries, Ltd., and thus, the following Polymer 1 (Mn: 50,000, Mw/Mn: 1.3) having hydroxyl groups at both ends was synthesized.

In the following Polymer 1, A represents a polymer chain of n-butyl acrylate.

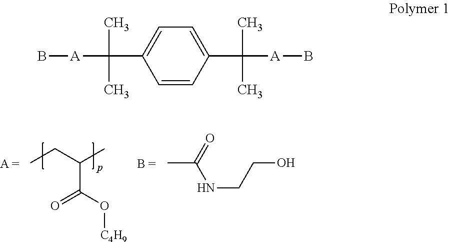

<Synthesis of Polymer 222

The following Polymer 2 (Mn: 52,000, Mw/Mn: 1.4) having methacroyl groups introduced at both ends was synthesized by adding 2-methacryloyloxyethyl isocyanate to the polymer obtained in the course of Synthesis of Polymer 1, and stirring the mixture at 80° C. for 5 hours. In the following Polymer 2, A represents a polymer chain of n-butyl acrylate.

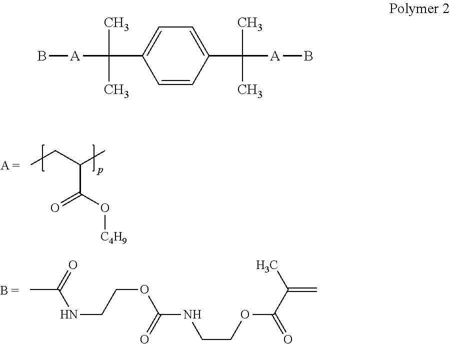

<Synthesis of Polymer 3>

Polymer 3 (Mn: 45,000, Mw/Mn: 1.5) having hydroxyl groups introduced at both ends was synthesized by carrying out the same operation as that carried out in Synthesis of Polymer 1, except that the radical initiator used in Synthesis of Polymer 1 was changed to VA-080 (2,2′-azobis(2-methyl-N-[1,1-bis(hydroxymethyl)-2-hydroxyethyl]propionamide) manufactured by Wako Pure Chemical Industries, Ltd. In the following Polymer 3, A represents a polymer chain of n-butyl acrylate.

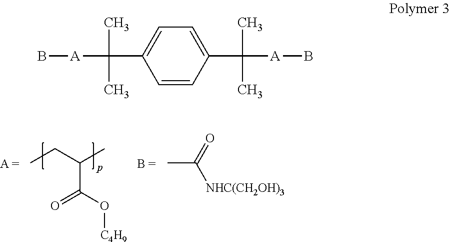

<Synthesis of Polymer 4>

The same operation as in Synthesis of Polymer 1 was carried out, except that the ethylenically unsaturated monomer used in Synthesis of Polymer 1 was changed to 2-methoxyethyl acrylate. 3-Isocyanatopropyltriethoxysilane was added thereto, and the mixture was stirred for 80° C. for 3 hours. Thus, the following Polymer 4 (Mn: 34,000, Mw/Mn: 1.5) having triethoxysilanes introduced at both ends was synthesized. In the following Polymer 4, A represents a polymer chain of 2-methoxyethyl acrylate.

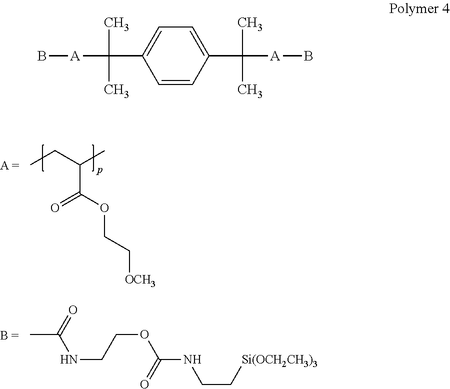

<Synthesis of Polymer 5>

The same operation as in Synthesis of Polymer 4 was carried out, except that the terminal reactive agent used in Synthesis of Polymer 4 was changed to 2-methacryloyloxyethyl isocyanate, and thus, the following Polymer 5 (Mn: 52,000, Mw/Mn: 1.6) having methacroyl groups introduced at both ends was synthesized. In the following Polymer 5, A represents a polymer chain of 2-methoxyethyl acrylate.

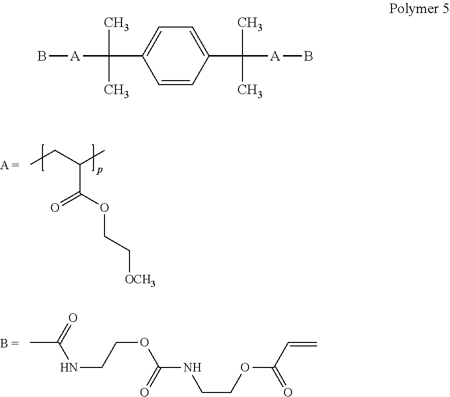

<Synthesis of Polymer 6>

Polymer 6 (Mn: 26,000, Mw/Mn: 1.3) was synthesized by the same method as described in Example 1 of JP-A-2008-81738. In the following Polymer 6, A represents a polymer chain of n-butyl acrylate.

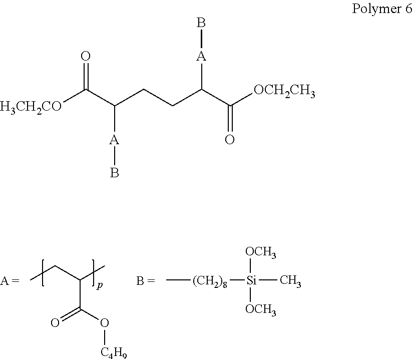

<Synthesis of Comparative Polymer R1>

Under a nitrogen gas stream, 2-methoxyethyl acrylate and 2-hydroxyethyl acrylate (molar ratio: 97/3) were polymerized in polypropylene glycol monomethyl ether acetate (PGMEA) at 80° C. by using an initiator V-601 (manufactured by Wako Pure Chemical Industries, Ltd.), and Polymer R1 (Mn: 55,000, Mw/Mn: 2.59) having a hydroxyl group introduced into a side chain was obtained.

### <Synthesis of Comparative Polymer R2>

Under a nitrogen gas stream, 2-methoxyethyl acrylate was polymerized in PGMEA at 110° C. by using an initiator VA-086, and thus, Polymer R2 (Mn: 115,000, Mw/Mn: 2.78) having a hydroxyl group introduced at one end of the polymer main chain was obtained.

<Synthesis of Comparative Polymer R3>

Synthesis was carried out in the same manner as in Synthesis of Comparative Polymer R1, except that polymerization was performed at 110° C. by changing the initiator used in Synthesis of Comparative Polymer R1 to VA-086, and thus, Polymer R3 (Mn: 45,000, Mw/Mn: 2.78) having hydroxyl groups introduced at one end of the polymer main chain and in a side chain was obtained.

### Example 1

1. Preparation of Resin Composition for Laser Engraving

Into a three-necked flask equipped with a stirring blade and a cooling tube, 50 parts of Polymer 1 of Component A and 47 parts of propylene glycol monomethyl ether acetate as a solvent were introduced, and while being stirred, the components were heated at 70° C. for 120 minutes to dissolve the polymer. Subsequently, the solution was adjusted to 40° C., and 25 parts of S-32 (described later) as (Component B) crosslinking agent, 0.5 parts of t-butylperoxybenzoate (trade name: PERBUTYL Z, manufactured by NOF Corp.) as a polymerization initiator, and 1 part of KETJEN BLACK EC600JD (carbon black, manufactured by Lion Corp.) as (Component C) photothermal conversion agent were further added to the solution. The mixture was stirred for 30 minutes. Through this operation, a coating liquid for forming a crosslinkable relief-forming layer 1 (resin composition for laser engraving 1) having fluidity was obtained.

2. Production of Flexographic Printing Plate Precursor for Laser Engraving

A spacer (frame) having a predetermined thickness was installed on a polyethylene terephthalate (PET) substrate, and the coating liquid for forming a crosslinkable relief-forming layer 1 obtained as described above was gently flow cast thereon so as not to flow out over the spacer (frame). The cast coating liquid thus cast was dried in an oven at 70° C. for 3 hours. Thereafter, the system was heated for 3 hours at 80° C. and for another 3 hours at 100° C. to thermally crosslink the relief-forming layer, and thus a relief-forming layer having a thickness of approximately 1 mm was provided. Thus, a flexographic printing plate precursor for laser engraving 1 was produced.

3. Production of Flexographic Printing Plate

The relief-forming layer after crosslinking (crosslinked relief-forming layer) was engraved with the following two kinds of lasers.

As a carbon dioxide gas laser engraving machine, a high-resolution CO₂ laser marker ML-9100 series (manufactured by Keyence Corp.) was used. A solid area which measured 1 cm on each of four sides was laser-engraved with the carbon dioxide laser engraving machine under the conditions of a power output of 12 W, a head speed of 200 mm/sec, and a pitch of 2,400 DPI.

As a semiconductor laser engraving machine, a laser recording apparatus equipped with a fiber-coupled semiconductor laser (FC-LD) SDL-6390 (manufactured by JDSU Corp., wavelength: 915 nm) having a maximum output power of 8.0 W was used. A solid area which measured 1 cm on each of four sides was laser-engraved with the semiconductor laser engraving machine under the conditions of a laser output power of 7.5 W, a head speed of 409 mm/sec, and a pitch of 2,400 DPI.

The thickness of the relief layer of the flexographic printing plate was approximately 1 mm.

### Examples 2 to 8, Comparative Examples 1 to 3

1. Preparation of Crosslinkable Resin Composition for Laser Engraving

Coating liquids for crosslinkable relief-forming layer (resin compositions for laser engraving) 1 to 8 and comparative coating liquids for crosslinkable relief-forming layer (resin compositions for laser engraving) 1 to 3 were prepared in the same manner as in Example 1, except that Component A, Component B, and the additives used in Example 1 were changed as indicated in the following Table 1.

The details of Component A, Component B, and the additives used in the respective Examples and Comparative Examples are as follows.

(Component A)
Polymers 1 to 6: See Synthesis of Polymers 1 to 6 described above
Comparative Polymers R1 to R3: See Synthesis of Comparative Polymers R1 to R3 described above

(Component B)
BLENMER PDE-200: Polyethylene glycol dimethacrylate ((meth)acrylate compound), manufactured by NOF Corp.
Compound S-32 (silane coupling agent): Compound represented by the following formula (wherein Me represents a methyl group)

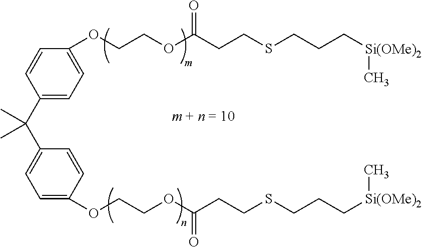

(Additives)
PERBUTYL Z: Polymerization initiator, t-butyl peroxybenzoate, manufactured by NOF Corp.
DBU: 1,8-Diazabicyclo[5.4.0]undec-7-ene

2. Production of Flexographic Printing Plate Precursor for Laser Engraving

Production was carried out in the same manner as in Example 1, except that the coating liquid for crosslinkable relief-forming layer 1 in Example 1 was changed respectively to the coating liquids for forming a crosslinkable relief-forming layer 2 to 8 and comparative coating liquids for forming a crosslinkable relief-forming layer 1 to 3. Thereby, flexographic printing plate precursors for laser engraving 2 to 8 of Examples and flexographic printing plate precursors for laser engraving 1 to 3 of Comparative Examples were obtained.

3. Production of Flexographic Printing Plate

In the same manner as in Example 1, the relief-forming layers of the flexographic printing plate precursors for laser engraving 2 to 8 of Examples and the flexographic printing plate precursors for laser engraving 1 to 3 of Comparative Examples were thermally crosslinked, and then the relief-forming layers thereof were engraved to form relief layers. Thereby, flexographic printing plates 2 to 8 of Examples and flexographic printing plates 1 to 3 of Comparative Examples were obtained.

The thickness of the relief layers of these flexographic printing plates was approximately 1 mm.

4. Evaluation of Flexographic Printing Plate

A performance evaluation of the flexographic printing plates was carried out on the following items, and the results are shown in Table 1. The evaluation results obtained in the case of performing engraving with a carbon dioxide gas laser, and the evaluation results obtained in the case of performing engraving with a semiconductor laser were the same.

5. Print Durability

The relief printing plates thus obtained were mounted on a printing machine (ITM-4 type, manufactured by lyo Kikai Seisakusho Co., Ltd.). Printing was continuously carried out by using an aqueous ink, AQUA SPZ16 Red (manufactured by Toyo Ink Group) as an ink, without diluting the ink, and by using Full-color Form, M 70 (manufactured by Nippon Paper Group, thickness: 100 μm) as a printing paper. Highlight percentage of 1% to 10% was confirmed on the printed material. The time point at which unprinted halftone dots were generated was defined as the termination of printing, and the length (meters) of printed paper until the termination of printing was used as an index. A larger value was evaluated to indicate superior print durability.

The results are shown in Table 1.

6. Breaking Strength of Film

The breaking strength values of the cured films (relief layers) obtained by curing the resin compositions for laser engraving of Examples and Comparative Examples were measured as follows.

Measurements were carried out by using SHIMADZU AGSH5000 manufactured by Shimadzu Corp. as a tensile tester, and by processing the specimen shape into the dumbbell type defined by the JIS standards (measurement was made by inputting the average of horizontal width as 2.25 cm). The measurement environment was adjusted to a temperature of about 21° C., a humidity of 60%, and a tensile speed of 2 mm/min. A larger value indicated superior strength of the relief layer.

TABLE 1

| | | Main chain | (Component | | | |
|---|---|---|---|---|---|---|
| | | end | B) | | Breaking | Print |
| | | structure of | Crosslinking | | strength | durability |
| | Component A | Component A | agent | Additive | (N/cm) | (m) |
| Example 1 | Polymer 1 | Hydroxyl | S-32 | DBU | 19 | 2,000 |
| | | group | | | | |
| Example 2 | Polymer 2 | Ethylenically | None | PERBUTYL Z | 24 | 2,400 |
| | | unsaturated | | | | |
| | | group | | | | |
| Example 3 | Polymer 2 | Ethylenically | BLENMER | PERBUTYL Z | 27 | 2,700 |
| | | unsaturated | PDE-200 | | | |
| | | group | | | | |
| Example 4 | Polymer 3 | Hydroxyl | None | None | 19 | 1,900 |
| | | group | | | | |
| Example 5 | Polymer 3 | Hydroxyl | S-32 | DBU | 20 | 2,100 |
| | | group | | | | |
| Example 6 | Polymer 4 | Trialkoxysilyl | None | DBU | 19 | 1,700 |
| | | group | | | | |
| Example 7 | Polymer 5 | Ethylenically | None | PERBUTYL Z | 25 | 2,400 |
| | | unsaturated | | | | |
| | | group | | | | |
| Example 8 | Polymer 6 | Dialkoxysilyl | None | PERBUTYL Z | 22 | 2,300 |
| | | group | | | | |
| Comparative | Polymer R1 | Hydroxyl | S-32 | DBU | 5 | 400 |
| Example 1 | | group in | | | | |
| | | side chain | | | | |
| Comparative | Polymer R2 | Hydroxyl | S-32 | DBU | 3 | 150 |
| Example 2 | | group in one | | | | |
| | | end | | | | |
| Comparative | Polymer R3 | Hydroxyl | S-32 | DBU | 7 | 550 |
| Example 3 | | group in one | | | | |
| | | end and | | | | |
| | | side chain | | | | |

What is claimed is:

1. A resin composition for laser engraving, comprising:
(Component A) a polymer having a constituent unit derived from an ethylenically unsaturated monomer, and having at least two functional groups selected from the group consisting of an ethylenically unsaturated group, a hydroxyl group, and an alkoxysilyl group at the main chain ends.

2. The resin composition for laser engraving according to claim 1, wherein the molecular weight dispersity (Mw/Mn) of Component A is at least 1.0 but no greater than 1.6.

3. The resin composition for laser engraving according to claim 1, wherein Component A is a linear polymer represented by Formula (I): 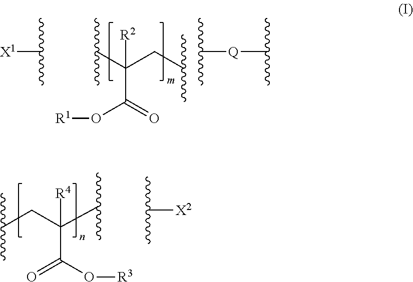
wherein in Formula (I), Q represents a divalent organic linking group; R¹ and R³ each independently represent an alkyl group; R² and R⁴ each independently represent a hydrogen atom or a methyl group; X¹ and X² are respectively located at the main chain ends and each independently represent an organic residue having a group selected from the group consisting of an ethylenically unsaturated group, a hydroxyl group, and an alkoxysilyl group at the end; m and n each independently represent an integer of 4 to 1,000; and a wavy line portion represents a position of bonding to another structure.

4. The resin composition for laser engraving according to claim 2, wherein Component A is a linear polymer represented by Formula (I): 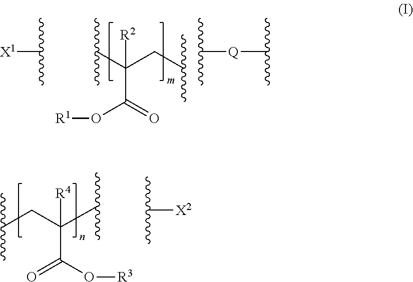
wherein in Formula (I), Q represents a divalent organic linking group; R¹ and R³ each independently represent an alkyl group; R² and R⁴ each independently represent a hydrogen atom or a methyl group; X¹ and X² are respectively located at the main chain ends and each independently represent an organic residue having a group selected from the group consisting of an ethylenically unsaturated group, a hydroxyl group, and an alkoxysilyl group at the end; m and n each independently represent an integer of 4 to 1,000; and a wavy line portion represents a position of bonding to another structure.

5. The resin composition for laser engraving according to claim 1, wherein Component A is a linear polymer represented by Formula (II): 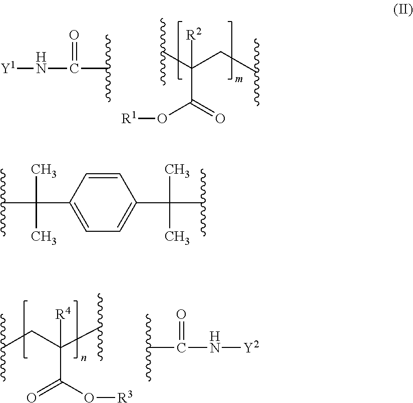
wherein in Formula (II), R¹ and R³ each independently represent an alkyl group; R² and R⁴ each independently represent a hydrogen atom or a methyl group; Y¹ and Y² each independently represent an organic residue having a group selected from the group consisting of an ethylenically unsaturated group, a hydroxyl group, and an alkoxysilyl group at the end; m and n each independently represent an integer of 4 to 1,000; and a wavy line portion represents a position of bonding to another structure.

6. The resin composition for laser engraving according to claim 2, wherein Component A is a linear polymer represented by Formula (II): 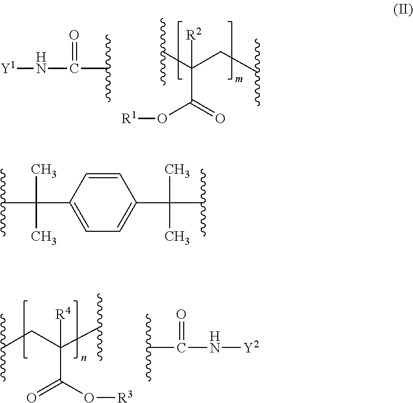
wherein in Formula (II), R¹ and R³ each independently represent an alkyl group; R² and R⁴ each independently represent a hydrogen atom or a methyl group; Y¹ and Y² each independently represent an organic residue having a group selected from the group consisting of an ethylenically unsaturated group, a hydroxyl group, and an alkoxysilyl group at the end; m and n each independently represent an integer of 4 to 1,000; and a wavy line portion represents a position of bonding to another structure.

7. The resin composition for laser engraving according to claim 5, wherein in Formula (II), m and n each represent an integer of 100 to 300.

8. The resin composition for laser engraving according to claim 1, further comprising (Component B) a crosslinking agent.

9. The resin composition for laser engraving according to claim 8, wherein Component B is a silane coupling agent or a polyfunctional (meth)acrylate.

10. The resin composition for laser engraving according to claim 1, further comprising (Component C) a photothermal conversion agent.

11. The resin composition for laser engraving according to claim 1, further comprising a tertiary amine and/or an organic peroxide as (Component D) a crosslinking accelerating agent.

12. A flexographic printing plate precursor for laser engraving, having a relief-forming layer comprising the resin composition for laser engraving according to claim 1.

13. A flexographic printing plate precursor for laser engraving, having a crosslinked relief-forming layer produced by crosslinking a relief-forming layer comprising the resin composition for laser engraving according to claim 1, by means of light and/or heat.

14. A process for producing a flexographic printing plate precursor for laser engraving, the process comprising,
a layer forming step of forming a relief-forming layer comprising the resin composition for laser engraving according to claim 1, and
a crosslinking step of crosslinking the relief-forming layer by means of light and/or heat to obtain a flexographic printing plate precursor having a crosslinked relief-forming layer.

15. The process for producing a flexographic printing plate precursor for laser engraving according to claim 14, wherein the crosslinking step is a step of crosslinking the relief-forming layer by heat to obtain the flexographic printing plate precursor having the crosslinked relief-forming layer.

16. A process for making a flexographic printing plate, comprising:
an engraving step of laser-engraving the flexographic printing plate precursor according to claim 13 to thus form a relief layer.

17. A flexographic printing plate having a relief layer made by the process for making a flexographic printing plate according to claim 16.

18. A process for making a flexographic printing plate, comprising:
a step of preparing a flexographic printing plate precursor comprising a coating step (1) of applying, on a support, a resin composition comprising (Component A) a polymer that has a constituent unit derived from an ethylenically unsaturated monomer, has at least two functional groups selected from the group consisting of an ethylenically unsaturated group, a hydroxyl group and an alkoxysilyl group at the main chain ends, and has a molecular weight dispersity (Mw/Mn) of at least 1.0 but no greater than 1.6, and a curing step (2) of thermally curing the resin composition, and
a step of laser-engraving the flexographic printing plate precursor.

19. The process for making a flexographic printing plate according to claim 18, comprising, subsequently to the steps (1) and (2),
a step of providing a photocurable composition layer on the surface of the thermally cured resin composition,
a step of pasting another light-transmissive support on the photocurable composition layer, and
a step of photo-curing the photocurable composition.
